(19) United States
(12) Patent Application Publication
(10) Pub. No.: US 2002/0035493 A1
(43) Pub. Date: Mar. 21, 2002

(54) Method and system for coordinating appointments

(76) Inventors: Bahram Mozayeny, Edina, MN (US); James E. Asbury, Bloomington, MN (US)

Correspondence Address: James H. Ackley, Dorsey & Whitney LLP, 220 South Sixth Street, Minneapolis, MN, 55402-1498, US

(21) Appl. No.: 09/928,535

(22) Filed: Aug. 13, 2001

Related U.S. Application Data
(63) Continuation-in-part of application No. 09/477,573, filed on Jan. 4, 2000.

(51) Int. Cl. G06F 17/60

(52) U.S. Cl. 705/5

(57) ABSTRACT

A method and apparatus for scheduling appointments. The method comprises receiving appointment availability information from a second party, receiving an appointment request from a first party, comparing the request to the availability information, automatically scheduling the appointment if the request is for an available time based on the availability information, and automatically updating the appointment availability information to reflect the appointment. The apparatus comprises an appointment server containing instructions for receiving appointment availability information from a second party, receiving an appointment request from a first party, comparing the request to the availability information, automatically scheduling the appointment if the request is for an available time based on the availability information, and automatically updating the appointment availability information to reflect the appointment.

### RELATED APPLICATIONS

This application is a continuation-in-part of copending U.S. patent application No. 09/477,573, filed Jan. 4, 2000, entitled “A Method and System for Coordinating Real Estate Appointments,” by Bahram Mozayeny et al., which is hereby incorporated by reference in its entirety.

### TECHNICAL FIELD

This invention relates to computerized methods and systems for businesses and systems for automatically scheduling appointments and reservations, and automatically notifying parties of delays or cancellations. The present invention can be used in many different applications, such as the real estate business, the medical and dental business, legal practice, the restaurant industry, the airline industry, and school systems. More particularly, this invention relates to computerized methods and systems for communicating and setting up appointments, monitoring activity, and automatically communicating delays or cancellations to parties. The methods are implemented in computer hardware and software systems.

### BACKGROUND

FIG. 1 illustrates a typical process for scheduling an appointment or making a reservation. When a first party 100 wishes to schedule an appointment or reservation, they communicate 102, typically via a telephone, with a second party 104 they wish to schedule with. The second party 104 typically accesses 106 a database 108 which contains a listing of the current schedule along with any available time slots or reservations. The database 108 can be a written calendar, a planner, or even a computer. The second party 104 then communicates the results 110 back to the first party 100, allowing the first party 100 to choose the available seat, time slot, or day, whereupon the first party 100, communicates information 112 back to the second party 104, such as name, telephone number, address, credit card number, and preferences. The second party 104 takes all of this information down, and inserts it 116 into the database 108, thus updating the database 108 to include the first party's 100 information. The information 112 can also be feedback or other information relating to the appointment or reservation.

If a situation arises where the scheduled item or time for the first party 100 is delayed or cancelled, the second party 104 may or may not try to contact 114 the first party 100 to inform them. Many times, it depends on what information was initially received. If the first party 100 did not leave a telephone number, there is very little chance they will be informed of the delay or cancellation, until they arrive at the respective place of the reservation or appointment.

It should be understood, that the caption “Party 1” in FIG. 1 may represent more than one person or entity, and that the caption “Party 2” may also represent one or more entities. For instance, “Party 1” may be a buyer, and the buyer's agent, and “Party 2” could represent a seller and the seller's agent. In these cases, the multiple entities representing either “Party 1” or “Party 2,” can communicate with each other as well as with the other party or entities of the other party.

There are a myriad of businesses and systems which follow this basic model of scheduling and taking reservations. Some examples are real estate transactions, scheduling appointments at practitioner's offices, making reservations at a restaurant, making reservations on an airline, and scheduling substitute teachers, just to name a few.

The method and system described above have a number of disadvantages. First, the method requires a great deal of human interaction on behalf of both parties. For example, the first party 100 and the second party 104 must constantly interact, which increase costs and requires parties to spend a significant amount of time scheduling appointments. The database 108 contains information for appointments and reservations and aids the first party 100 in scheduling an appointment or reservation, but it does not automate the scheduling process. The first party 100 must therefore request 102 a reservation or appointment time over the phone, and the second party 104 must communicate 110 this request to the database 108. Such a process requires a great deal of human interaction on behalf of both of the parties 100, 104. Reducing the amount of human interaction would decrease costs and would save parties such as real estate agents, practitioners, restaurants, airlines, consumers or schools a significant amount of time in scheduling appointments.

A second problem with the process of FIG. 1 is that it is difficult for the second party 104 to collect useful information from the other party that can be used to improve the business. For example, a feedback process between the parties 100, 104 makes it difficult to collect useful information. Feedback can be required by the first party 100. The first party 100, however, does not receive a tangible benefit from giving feedback to the second party 104, and the feedback is therefore frequently not meaningful or timely.

A third problem with the process of FIG. 1 is that it does not automatically mine and make available statistical information that can be beneficial to the development of that business. Information such as requests for a specific information, the number of information requests that do not result in appointments or reservations, the number of information items for which no further inquiries were made by the first party 100, or other market information relevant to second parties 104 that are typically not made available to second parties 104.

Yet another problem with the process illustrated in FIG. 1 exists where the appointment or reservation needs to be delayed or cancelled by either party. In this situation, a phone call must be made to the non-canceling party to inform them that the appointment or reservation needs to be delayed or cancelled. This can be a problem, especially where the canceling or delaying party needs to contact the other party at the last moment, but does not have a cell phone or pager number for that party. For example, if a flight is cancelled, the airline would need to contact every passenger on that flight, or a restaurant would need to contact every patron that would be affected by a delay.

Sometimes a third party is involved in the process. In a situation where a third party, such as a friend picking up a passenger from a destination airport, would find delay or cancellation information useful, there is little chance that the second party 104 will have the information, and will communicate the information to the third party.

There is a need in the art for a method and system to automate the appointment and reservation process for transactions. Such a method and system is also needed to facilitate and automate the feedback process between parties, and to mine useful information for use by those parties. In addition, a method and system that enables collecting and making available to parties market information relevant in a usable form is desirable. A method and system is also needed to automate the process of informing a party of cancellations or delays, and communicating information to third parties.

### SUMMARY

The present invention includes a method and apparatus for scheduling appointments.

In one embodiment, the method for scheduling an appointments comprises receiving appointment availability information from a second party, receiving an appointment request from a first party, comparing the request to the availability information, automatically scheduling the appointment if the request is for an available time based on the availability information, and automatically updating the appointment availability information to reflect the appointment. The method can also include verifying the appointment with the first party, automatically prompting another request if the request is for an unavailable time based on the availability information, requesting contact information from the first party, or automatically contacting the first party if there is any change in the appointment. Appointment information can be automatically sent to the first party or second party via email, fax, or IVR.

In another embodiment, the present invention is an apparatus for scheduling an appointment, the apparatus comprising an appointment server containing instructions for receiving appointment availability information from a second party, receiving an appointment request from a first party, comparing the request to the availability information, automatically scheduling the appointment if the request is for an available time based on the availability information, and automatically updating the appointment availability information to reflect the appointment. The server can contain instructions for verifying the appointment with the first party, automatically prompting another request if the request is for an unavailable time based on the availability information, requesting contact information from the first party, or automatically contacting the first party if there is any change in the appointment.

In one embodiment, the first party is a passenger, the second party is an airline, and the appointment is an airline reservation. Third party information can be received, wherein the third party transports the first party to a departure airport or from a destination airport. Information can be automatically sent to the third party via email, fax or IVR.

In another embodiment, the first party is a patron, the second party is a restaurant, and the appointment is a dining reservation.

In another embodiment, the first party is a patient, the second party is a practitioner, and the appointment is an office appointment. The practitioner can be any practitioner, such as a doctor or a dentist.

In another embodiment, the first party is a school, the second party is a teacher, and the appointment is a class at the school.

In another embodiment, the first party is a teacher, the second party is a school, and the appointment is a class at the school.

While multiple embodiments are disclosed, still other embodiments of the present invention will become apparent to those skilled in the art from the following detailed description, wherein is shown and described only the embodiments of the invention, by way of illustration, of the best modes contemplated for carrying out the invention. As will be realized, the invention is capable of modifications in various obvious aspects, all without departing from the spirit and scope of the present invention. Accordingly, the drawings and detailed description are to be regarded as illustrative in nature and not restrictive.

### DESCRIPTION OF THE DRAWINGS

FIG. 1 is a block diagram overview of a prior art method and system for making appointments or reservations.

FIG. 2 is a basic block diagram overview of the system of the present invention.

FIG. 3 is a block diagram overview of the system of the present invention that illustrates the flow of communications in the present invention.

FIG. 4 is a block diagram overview of the system of the present invention.

FIG. 5 is a flow chart showing the scheduling and appointment process of the present invention.

FIG. 6 is a flow chart showing the cancellation or delay communication process of the present invention.

FIG. 7 is a block diagram overview of a prior art method and system for making appointments for real estate showings.

FIG. 8 is a basic block diagram overview of the system of one embodiment of the invention.

FIG. 9 is a block diagram overview of one embodiment of the system of the invention that illustrates the flow of communications in the invention.

FIG. 10 is a block diagram overview of an embodiment of the system of the invention.

FIG. 11 is a web page or database entry for registration of realtors with the system and method of one embodiment of the invention.

FIG. 12 is a web page or database entry for new property listings with the system and method of one embodiment of the invention.

FIG. 13 is a flow chart showing the scheduling and appointment process of one embodiment of the invention.

FIG. 14 is a web page or database entry for a feedback request for use in one embodiment of the invention.

FIG. 15 is a block diagram overview of a prior art method and system for making a flight reservation.

### DETAILED DESCRIPTION

### I. General Overview and Equipment of an Embodiment of the Invention

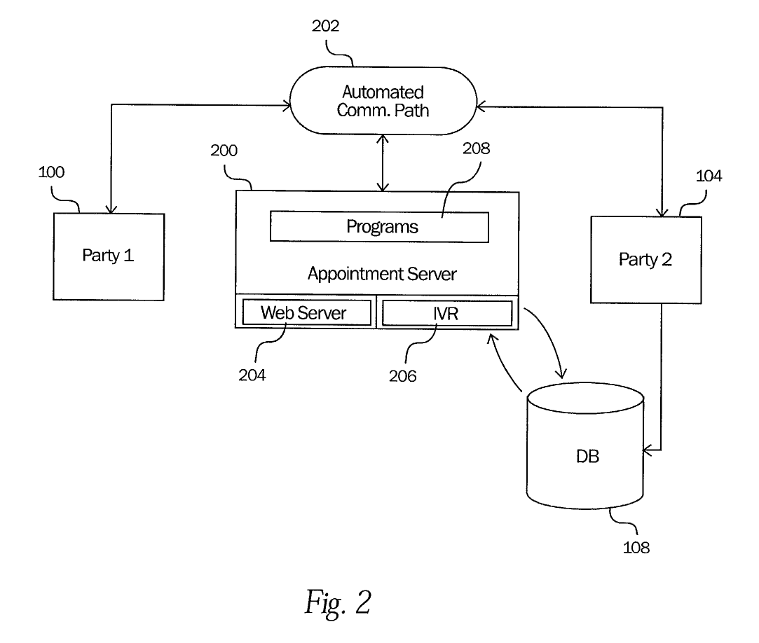

FIG. 2 shows a basic block diagram overview of the system of the present invention. As shown in FIG. 2, the system includes a first party 100, a second party 104, a database 108, an automated communications path 202, and an appointment server 200 having a web server 204, an interactive voice response system (“IVR”) 206 , and programs 208. In the present invention, the appointment server 200 communicates with one or more parties over a communication path 202. As shown in FIG. 2, the appointment server 200 communicates with a first party 100 and a second party 104 over communication path 202. The communication path 202 used within the scope of the invention may be a Local Area Network (“LAN”) of any type, a Wide Area Network (“WAN”), a private network, a public network including the Internet and the Web, or a telephone network. Communications may be accomplished using standard devices or wireless devices such as telephones, cellular phones, palm pilots, satellite dishes, fax machines, the World Wide Web, cable, or other electronic communication devices or mediums known to those skilled in the art.

A database 108 may also be used within the scope of the present invention, although the database 108 may also be replaced entirely in one embodiment of the invention by the appointment server 200, which may contain database information relevant to the use of the appointment server 200, such as real estate listings, available dates and times at a restaurant, flight information, substitute teacher schedules, or available time slots at a practitioner's office, just to name a few. In an embodiment using the database 108, the appointment server 200 may communicate with the database 108 to upload and gather relevant information. Similarly, information added through the appointment server 200 may also be communicated to the database 108 so that information is contained in the database 108. In some embodiments, the database 108 may be used for reference from the appointment server 200, such as by providing an Internet link to the database 108 from a web page in the appointment server 200. In another embodiment using the database 108, addresses, pictures, and other such types of information, as well as other information, may be uploaded from the database 108 to the appointment server 200. The database 108, therefore, may be either integral with the appointment server 200 or a completely separate system that is used only for reference from the appointment server 200.

As shown in FIG. 2, the appointment server 200 may include a web server 204, an IVR system 206, and programs 208. In the embodiment shown in FIG. 2, the appointment process is automated. The web server 203 may be separate, or included as part of the same computer system, as the appointment server 200, and operates a web site that allows for communication with a first party 100 and/or a second party 104. In one embodiment, the web server 204 manages all or a portion of the e-mail and Internet communications for the appointment server 200. The appointment server 200 may be any standard computer known to those skilled in the art and may contain a processor, input and output devices, and other conventional features for computer servers. Although the appointment server 200 will be referred to throughout this specification as a single computer, it may be any number of computers networked together into a computer system or it may be one or more computer servers operating over the Web. In addition, the appointment server 200, in one embodiment, includes an IVR system 206 that also allows for communication to and from the appointment server 200 through telephone rather than the Web.

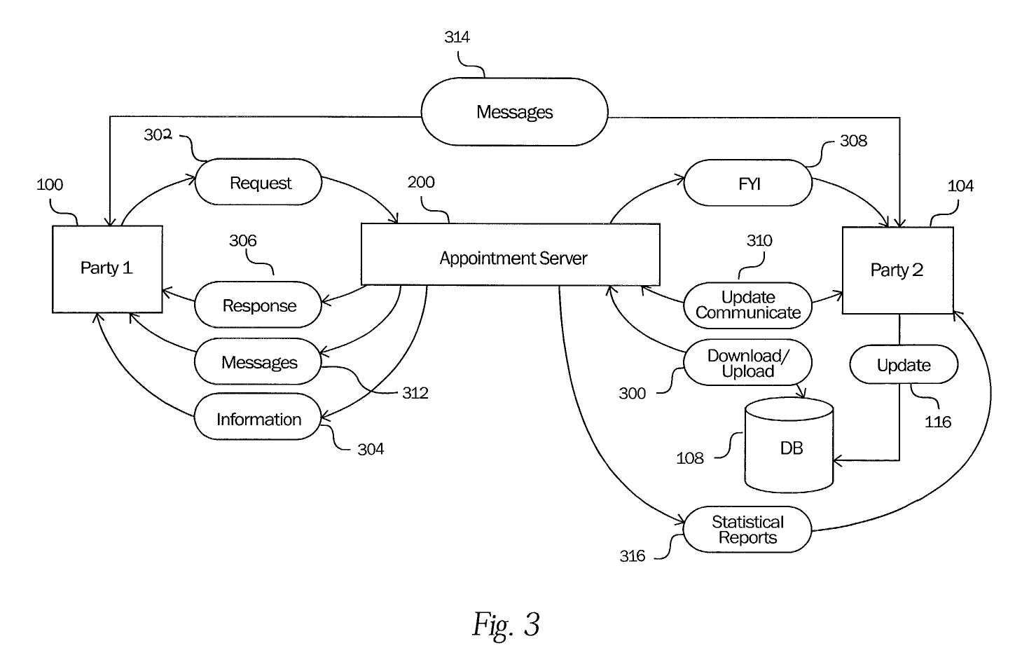

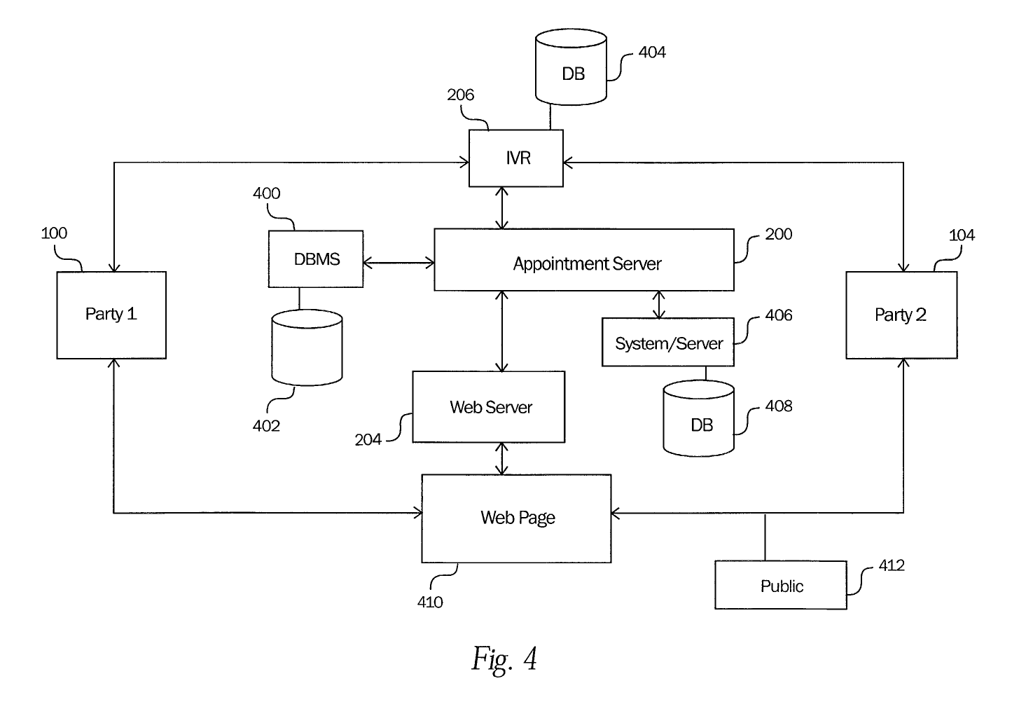

FIGS. 3 and 4 illustrate more detailed embodiments of the appointment server 200 of the present invention. FIG. 3 illustrates the communications that can take place between the parties 100, 104 and the appointment server 200, and FIG. 4 illustrates that the appointment server 200 may contain a number of databases or servers, which may be either separate computers or computer systems from the appointment server 200 or applications or databases running on the appointment server 200. As shown in FIG. 4, the appointment server system includes an appointment server 200 having a database management system 400 with a database management system database 402, an IVR system 206 with an IVR database 404, other systems and servers 406 having their own respective databases 408, and a web server 204 that runs a web page 410. As shown in FIG. 4, a database management server 400 and database 402 that stores relevant information, historical data, and other programs or information may be part of the appointment server 200. The IVR system 206 may have a server and database 404 to provide for the operation and data storage of the voice response system of the invention. Other servers 406 (e.g. Text to Speech, Speech Recognition, Accounting Servers, etc.) and databases 408 may also be a part of the appointment server 200. It is to be understood that these servers 406 and databases 408 may be used together or separately, may exist within the appointment server 200 or separately or at a remote site. As such, these databases 408 and servers 406 illustrate that a number of components to the appointment server 200 may exist. In addition, the system and method of the invention may coordinate in uploading and/or downloading information from the database 108, as shown in FIGS. 2 and 3 (numeral 300 of FIG. 3).

Any computer systems and software programs known to those skilled in the art may be used within the scope of the invention. In one embodiment, a SUN computer with the Solaris operating system may be used for the appointment server 200, a Compaq computer with the LINUX operating system may be used for the web server 204, and a Compaq computer with WindowsNT, Windows 95, Windows 98, or Windows 2000 may be used for the servers 406 and IVR system 206. An ORACLE database management system may be used for the database management server 400, Dialogic communication hardware and software may be used for the telephony and voice communication applications, and Nuance software may be used for intelligent voice recognition. For the other features described below, such as mapping, TileGen and IPS software from VectorVision Corp. may be used for map selection and for identification on maps, and Map Objects software from Environmental Sciences Research Institute may be used for map creation and for the Geographic Information System to overlay different layers of information on a map. It is to be understood that other computer systems and software known to those skilled in the art may also be used. In addition, software or programs 208 within the servers or databases of the appointment server 200 or elsewhere may be used to carry out the functions and operations described above and below.

The web server 204 or IVR system 206 may be set up so that only certain parties have access thereto, via either password protection or secured communications paths, although full or partial access may be given to other parties in other embodiments. The references to a first party 100, a second party 104, and a third party 1516 in the Figures may refer to the person himself or herself and/or to the computer, computer system or telephone system used by that person for communication through the communication path 202. The web page 410 operated by the web server 204 may have portions that are available generally to the public 412, such as open house showings and maps to those showings, flight information, and/or available time slots at a restaurant or practitioner's office, as well as portions that may be accessed only by parties with accounts. The web site 410 may also have information such as online purchasing agreements, flight contracts, insurance forms, and the like for purchase or use, brochures or riders for advertising purposes, and links to other web sites that contain valuable information.

In one embodiment, a first party 100 may communicate with the appointment server 200 and request an appointment or reservation using either IVR 206, as is well known in the art, or using the Web 410. In the common situation in which the second party 104 will not allow an appointment or reservation to be made at any time, the appointment server 200 may automatically communicate with the second party 104, typically through the phone but possibly through e-mail or the Web, to request authorization to schedule the appointment or reservation. After the appointment server 200 has received a response from the second party 104, the response may be automatically communicated to the first party 100. In addition, records of requests for reservations or appointments, reservations or appointments that are actually set up, and records for other information may be saved in the appointment server 200 so that the records may be used for statistical or business purposes. The feedback process may also be automated by having the appointment server 200 automatically send an e-mail or other request to the first party 100 requesting general or specific information about the appointment or reservation. These and other features of the invention will be discussed further in the following section.

### II. Operation

FIGS. 2-4 are block diagrams illustrating embodiments of the system and operation of the present invention. Data collected from the first party 100 or the second party 104 may be stored in the appointment server 200 of the invention or in the various servers and databases depicted in FIG. 4. Numerous types of data can be collected from the parties and used in the present invention.

1. Compiling User Information in the Appointment Server

Parties 100, 104 may enroll with a system proprietor of the appointment server 200 by providing certain information. Any type of information may be requested, depending on the business or service the appointment server 200 is accommodating. Typically personal information and contact information is requested, so that the party can be identified and contacted if need be. The information may be provided via web pages 410, as depicted in FIG. 4, that are run through the web server 204 of the appointment server 200. The information may also be collected in a variety of other methods, such as by using an IVR system 206, through email, traditional mail, or through in-person or telephone conversations.

2. Compiling Other Information in the Appointment Server

A party 100, 104 may submit new information or an update to existing information through the appointment server 200. In an embodiment using the database 108, information submitted through the database 108 may be updated to the appointment server 200 on regular intervals so that the appointment server 200 has current information. Similarly, information may be downloaded from the appointment server 200 to the database 108. FIG. 3 indicates the uploading or downloading of information between the database 108 and the appointment server 200 as numeral 300, and the submission of information by the second party 104 to the database 108 as numeral 116. In addition, information added directly by the second party 104 to the appointment server 200 may be downloaded to the database 108 so that the database 108 has current information about those listings. In the event that listing information is uploaded from the database 108 to the appointment server 200 instead of added directly to the appointment server 200, the second party 104 may need to supply additional information, such as seller-specific information, to the appointment server 200 so that the method and system of the invention may operate. In such an embodiment, the appointment server 200 may send an e-mail to the second party 104 to request the information, or, in another embodiment, place an IVR phone call to request the information. It should also be understood that in one embodiment of the invention the database 108 may not be used, such that only that information added directly to the appointment server 200 will be used in operation of the invention.

For information added to the appointment server 200, such as participating businesses or locations of businesses, a map may be associated with the information to aid first parties 100 in finding the location of the business or service. The map may be a simple, low detailed map, or a higher detailed map of the area. The map may be generated automatically by the appointment server 200 by using well-known on-line map sources, such as Mapquest, or by asking the second party 104 to supply a map for inclusion in the information record. In addition to a map showing the location of the business or property, directions from well-known cities, landmarks, locations, highways, or roads may be included. In one embodiment, the maps may be large enough and detailed enough for use in a vehicle when driving to or between locations. The directions may also be provided by on-line sources or by the second party 104 himself or herself when entering the information.

3. Setting Up Appointments

a. Searching for Information

After parties have registered with the appointment server 200, the server may be used to find information with specific characteristics and to arrange for a reservation or appointment. The appointment server 200 may contain a web page that allows for searching for information by a first party 100. The web page may be any type of web page known to those skilled in the art and may use any known searching software or technique. A first party 100 may be required to log on to the web site, which may require password control, prior to searching for information. Searches may be conducted by any data type contained in the information, such as searches by area code, city, property type or style, price range, number of bedrooms, number of baths, airline, flight destination, flight origination, practitioner, practitioner location, insurance carrier, restaurant, city, state, or school. In one embodiment, searches conducted through the appointment server 200 may search through the database 108 for information, and display partial or entire records for any information in the database 108 that is not included in the appointment server's 200 records. Through the use of a single appointment server 200, or through a networked group of appointment servers 200, first parties 100 from many different locations can schedule appointments and/or make reservations.

Alternatively, a user may occur on another website, operated by another, that is linked to the appointment server web page. The user could search the remote web site, then link to the appointment server web page, the link optionally carrying the parameters identifying the selected information. The user could then proceed to schedule the appointment on the appointment server web page.

After a search has been conducted, the first party 100 may view records for the information retrieved in the search. The records may contain all or a portion of the information, and the record may be displayed with any pictures, maps, and directions to the location from nearby highways, roads, cities, or landmarks.

The first party 100 may next request those information items that he or she desires to reserve or schedule an appointment for. After the first party 100 selects those items, the appointment server 200 (and more specifically a map server) may generate a map showing the location of each item (with a number, letter, or otherwise), if pertinent. The map may also contain directions for the first party 100 so that the first party's 100 route to a location is defined. In another embodiment, a map with each retrieved information item may be displayed to the first party 100. FIG. 3 indicates requests from a first party 100, including a request for map information for as numeral 302 and a response with map information from the appointment server 200 as numeral 304. The map and directions may be printable so that the first party 100 can use the map and directions.

Certain information may be contained on a report that is for a first party's 100 eyes only. Such information includes lock box combinations, showing instructions, billing information, reservation information, insurance information, and other pertinent information.

A variety of other information may be presented to a first party 100 when results from a search are presented. Such information may include a color scheme showing the status of each information item (new, old listing, etc.), flags to indicate certain items, such as newly entered or recently cancelled items, and a list showing available times for appointments or reservations.

b. Scheduling Appointments and Making Reservations

Appointments may be automatically scheduled through the appointment server 200. Scheduling may take place prior to the generation of a map (described above) for the first party 100, so that the first party 100 can have confirmed appointment or reservation times prior to generation of a map and directions. It should be noted that the parties 100, 104 may continue to communicate with each other via telephone or other methods to keep professional relationships alive.

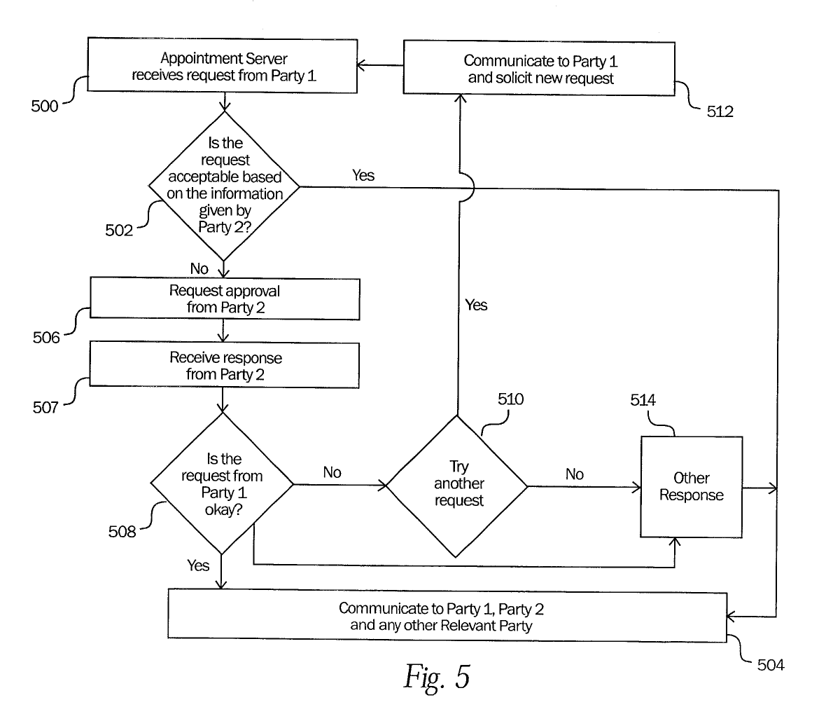

FIG. 5 is a flow chart of one embodiment of the scheduling and appointment process of the present invention, and FIG. 3 also depicts communications used in an embodiment of the invention. A first party 100 may request to schedule an appointment, or make a reservation, as depicted by numeral 302 in FIG. 3. As shown in FIG. 5, the appointment server 200 receives this request (block 500). In some listings, a second party 104 may indicate that certain times are acceptable for appointments or reservations, and that only notification is required to the second party 104. The appointment server 200, therefore, may query whether the requested appointment or reservation time is acceptable based on the record (FIG. 5, block 502). If the appointment or reservation time is acceptable, the first party 100 will be notified (via the Web, e-mail, or telephone or IVR), and notification may be sent to the parties 100, 104 (FIG. 5, block 504; FIG. 3 numerals 306 and 308). FIG. 3 also depicts communication between the second party 104 and the appointment server 200 for clarification or further information as numeral 310. When the first party 100 is notified that the appointment or reservation time is acceptable, the notification (Web, e-mail, telephone, or IVR) may include information which may be accessed from the appointment server 200 or a database 1003 attached thereto. In one embodiment, the first party 100 may be automatically provided with all of the information that is necessary for the appointment or reservation. In one embodiment, only a first party 100 with a password can access a web page or IVR messages that include responses from second parties 104 to requests to schedule appointments or reservations, so that any confidential information may be kept secure.

In the event that the appointment or reservation time is not automatically acceptable based on the information given by the second party 104, the appointment server 200 may place a call, via the IVR system 206, to the second party 104 to solicit appointment approval (FIG. 5, block 506; FIG. 3, numeral 310). The solicitation to the second party 104 may ask for a voice or touch-tone response indicating that the time is acceptable, not acceptable, or asking for some other response. The appointment server 200 then receives the response from the second party 104 (FIG. 5, Block 507). If the appointment or reservation time is acceptable (block 508 in FIG. 5), this information may be automatically communicated to the parties 100, 104. Information may also be provided to the first party 100 as discussed above.

If the appointment or reservation time is not acceptable and the first party 100 should try another time (block 510), a message may be sent via e-mail, telephone, or the Web to the first party 100 to communicate the second party's 104 response and to solicit a new request to schedule an appointment or reservation (block 512). If the second party 104 has some response other than yes or no or try another time (block 514), this message may be automatically communicated to the parties 100, 104. In an embodiment in which the appointment server 200 contains a list of available times for appointments or reservations, the list of acceptable times may be provided to the first party 100 in response to a request for an appointment or reservation (if the requested appointment or reservation time is not acceptable). The parties 100, 104 may then contact each other via traditional methods to resolve issues relating to the scheduling and, in one embodiment, the second party 104 may phone in through the IVR system 206 (or enter via the web site) a response to a request to schedule an appointment or reservation. In the event that the first party 100 is using the Web to request appointment or reservation times, the response from the second party 104 may be received through the Web in a matter of moments and, if a response from the second party 104 is not received within a threshold time period, a message may be displayed to the first party 100 to indicate that a response will be posted later or that the first party 100 will be notified via IVR, e-mail, or otherwise.

In one embodiment, information for second parties 104, such as scheduled or attempted appointments or reservations and requests to contact the second party 104, may be communicated via the IVR system 206 or via e-mail. In another embodiment, information for second parties 104 may be compiled in the appointment server 200 for presentation over the Web. In such a situation, the second party 104 may log on to the web site at a convenient time and check the status of specific items to determine whether appointments or reservations have been scheduled or attempted and to determine if there have been requests to contact the second party 104. Market intelligence and statistical reports may also be made available to the parties in such an embodiment.

A first party 100 may, in one embodiment of the invention, request multiple appointment or reservation times for different items based on search results of items through use of either the web server 204 of the appointment server 200 or through the IVR system 206. The first party 100 may then log off the web site (or hang up the phone), and then check to determine the status of the requested appointments or reservations by phone or through the web site at a later time. The first party may therefore arrange for several appointments or reservations at one time, in effect setting up a “tour” of appointments or reservations. After the first party 100 receives the results, the first party 100 may request different appointment or reservation times (depending on the second party's 104 response or changed circumstances) and then print a schedule and map for appointments or reservations. In other embodiments, the map for the appointments or reservations may be displayed and the first party 100 may click on scheduled items to delete or modify the appointment or reservation times. For instance, if a desired appointment time at one location is not available, a different appointment time may be needed for a number of the other locations of the tour. The appointment server 200 may assign an identification code to the tour, and, depending on the results of the requests for appointments or reservations, the first party 100 may recall the tour and modify requested appointment or reservation times without having to re-enter all of the information for the desired appointments or reservations a second time. The first party 100 may also change requested appointment or showing orders or dates. After the first party 100 has found an acceptable tour in terms of available appointment or reservation times, maps (showing directions between appointments or reservations) and any other information needed for an appointment or reservation, such as lock box combinations, showing directions, flight information, school schedule, insurance information, and location of the business or school, may be provided to the first party 100 for each item as discussed above. In many situations, second parties 104 are communicated with by the appointment server 200 quickly and a response from the second party 104 to the requested appointment or reservation is received by the first party 100 in a matter of minutes or even seconds.

4. Communicating Delays or Cancellations

Cancellations or delays of scheduled appointments or reservations may be automatically communicated to a party through the appointment server 200. It should be noted that the parties 100, 104 may continue to communicate with each other via telephone or other methods to keep professional relationships alive.

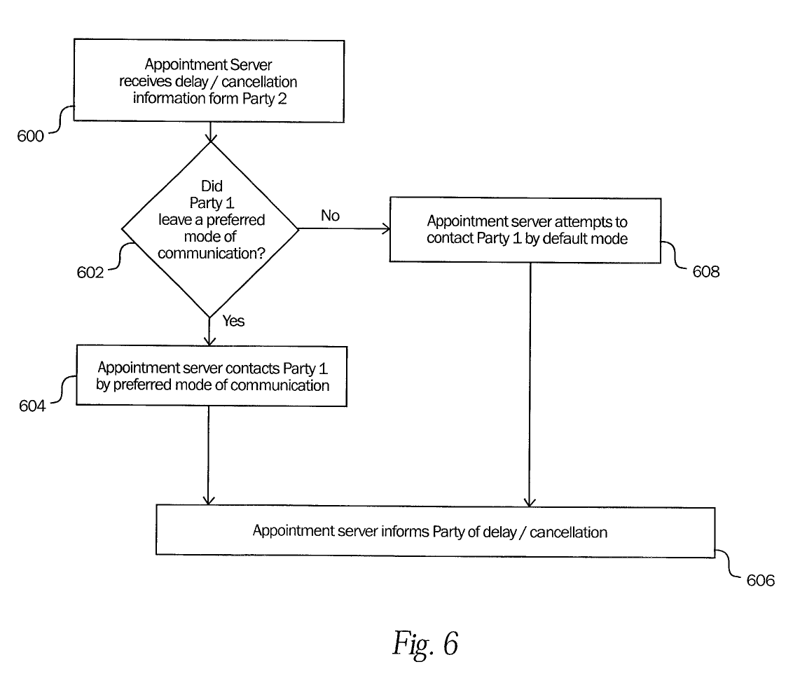

FIG. 6 is a flow chart of one embodiment of the cancellation or delay communication process of the present invention, and FIG. 3 also depicts communications used in an embodiment of the invention. In one embodiment, a first party 100 who has scheduled an appointment or reservation, as depicted in FIG. 5, will be automatically contacted by the appointment server 200 in the case of a delay or cancellation (numeral 312 of FIG. 3). As shown in FIG. 6, the appointment server 200 receives the cancellation or delay information (block 600) from the second party 104 (numeral 312 of FIG. 3). The appointment server 200 then queries whether the first party 100 listed a preferred mode of communication when scheduling the appointment or reservation (block 602). The preferred mode of communication can be a work telephone number, a home telephone number, a cell phone number, a pager number, an email address, a pager, or any other type of communication possible using a web server 204or IVR system 206. In one embodiment, the first user 100 can list a preferred mode of communication that is time dependent. For instance, between 9:00 AM and 5:00 PM, the preferred mode may be by an email message, or a work telephone number, but after 5:00 PM, the preferred mode may be by a pager number or home telephone number. The more detailed the information is, the better chance that the first party 100 will be contacted by the appointment server 200.

If the first party 100 did leave a preferred mode of communication, the appointment server 200 will attempt to contact the first party 100 by that preferred mode of communication (block 604). The appointment server 200 can use either a web server 204 or an IVR system 206 for making contact, depending on the mode of communication. Upon an answer to the communication attempt, the appointment server 200 can leave a message either in the form of a computerized voice message, or an electronic mail, relaying the cancellation or delay (block 606).

If the first party 100 did not leave a preferred mode of communication, the appointment server 200 can use a default method of communication to reach the first party 100 (block 608). The default mode of communication can be any mode of communication selected by the server 200 administrator or second party 104 that is used every time there is not a preferred mode of communication listed. In one embodiment, the default mode can be a home telephone number. The appointment server 200 can use either a web server 204 or an IVR system 206 for making contact, depending on the default mode of communication. Upon an answer to the communication attempt, the appointment server 200 can leave a message either in the form of a computerized voice message, or an electronic mail, relaying the cancellation or delay (block 606).

In an alternative embodiment, the appointment server 200 can attempt to contact a third party 1516, such as in a situation where a flight is late, and a passenger on the flight is going to be picked up by the third party 1516. If the passenger entered contact information for the third party, the appointment server 200 can contact any third party 1516 with information on the server 200 that will be affected by the delay or cancellation.

In another embodiment, If the appointment server 200 is not able to contact the first party 100, either by the preferred mode of communication, or by a default mode, the appointment server 200 may attempt to contact the first party 100 using alternative modes of communication, depending on the information entered into the server 200 by the first party 100. In one embodiment, the server 200 can have a pre-programmed order of modes of communication to use, such as cell phone number, pager number, e-mail, and so on, in case the server 200 is not able to make contact with the first party 100 initially.

It is to be understood, that the appointment server 200 can be set up in many different ways. In one embodiment, the appointment server 200 can be set up only to use a default mode of communication, and not a preferred mode. In another embodiment, the server 200 can be programmed to contact the first party 100 in multiple ways, such as a telephone call and an e-mail. In another embodiment, the server 200 can be set up to receive cancellation or delay information from a first party 100, and can communicate the delay or cancellation to the second party 104.

The automated communication system for relaying cancellations or delays saves the parties time and money. The canceling party only needs to input the information into the appointment server 200, and the appointment server 200 can make efforts to contact all interested parties to inform them of the cancellation or delay. This saves the canceling party the time required to contact multiple parties, while still putting forth great efforts to ensure that the parties are informed. This saves the non-canceling party the time wasted in showing up to an appointment or for a reservation that may not be ready, or may be cancelled.

5. Gathering Feedback

After an appointment or reservation has occurred, the appointment server 200 may automatically request feedback from the first party 100, as indicated by numeral 312 in FIG. 3. To automatically request this feedback, the appointment server 200 may simply request the feedback the day of the appointment or reservation or the day after an appointment or reservation was scheduled. The feedback may be requested by IVR, web page forms, or by e-mail. After the feedback has been received by the appointment server 200 from the first party 100, the feedback may be automatically communicated by e-mail or otherwise to the second party 104 (numeral 314 of FIG. 3). In another embodiment, the feedback request may be directed to the first party 100 but then sent via e-mail directly to the second party 104. The first party 100 may alternatively communicate feedback and other information to the second party 104 via traditional methods to ensure that a personal and professional relationship is maintained. In one embodiment, a thank you message may be sent (numeral 314 of FIG. 3) from the second party 104 to the first party 100 either after feedback has been received by the second party 104, or after the scheduled appointment or reservation has taken place.

6. Mining Information

Parties 100, 104 may check on the status of information items or view historical information through the appointment server 200. FIG. 3 depicts the availability of such statistical reports and information as numeral 316. Statistical information may be kept regarding how often a particular item has been retrieved as relevant to a first party's 100 search, how many requests to schedule an appointment or reservation have occurred, how many actual appointments or reservations have occurred, how many reservations or showings have been canceled, and other information that may be relevant to the ability of appointments and reservations to be made. Because prior art methods and systems have no direct route of tracking this information, the system and method of the invention may aid first and second parties in conducting business. Such information may be available through web pages within the appointment server 200, such that some web pages contain specific types of information, and other web pages contain more general information.

The web site of the appointment server 200 may provide a center for information for second parties 104 that contains feedback information from appointments or reservations, statistical information as described above for particular information items, and market activity. Such information may be viewed in yearly, monthly, weekly, or daily periods. Numerous types of information may be made available, including market activity trends pertaining to a particular information item, appointment or reservation activity for certain information items compared with activity for other similar items, geographic distribution information for items, and appointment or reservation and sales information for particular businesses and for the markets as a whole. In addition, other information may be provided, such as market activity with respect to the calendar time of the year.

Other possible data mining features include online search capabilities for items that meet certain selection criteria, along with mapping information, as described above, for those items. Potential first parties 100 may be profiled and certain items may be suggested as falling within categories (i.e., price, location, number of bedrooms) that such a profiled first party 100 may be interested in. Another possible feature is the profiling of items along with the actual first party 100 in an effort to determine if certain classes of products and/or services are likely to sell to those purchasers. Information first parties 100 may then be provided to vendors of products and/or services so that sales efforts may be made to the first party 100.

The appointment server 200 may have automated accounting and billing systems, which could be one of the servers 406 and databases 408 in FIG. 4, to automate the collection of billing information for the appointment server 200. The proprietor of the appointment server 200 may charge users based on usage of the appointment server 200. The appointment server 200 may, in one embodiment, charge first parties 100 based on searches for items, scheduled appointments or reservations, calls made to and from the IVR system 206, and based on usage of other features of the invention. In addition, second parties 104 may be charged based on scheduled appointments or reservations, information items listed with the appointment server 200, feedback submissions, or other usages of the appointment server 200. In other embodiments, users may be charged periodic fees, such as monthly fees, to use the appointment server 200. The accounting and billing systems of the appointment server 200 may track such billing information to automate accounting and billing procedures.

### III. Other Embodiments of the Invention

There are many embodiments of the present invention that overcome disadvantages of the prior art. Some examples are real estate showings, making an appointment at a practitioner's office, making a reservation at a restaurant, making a reservation on a flight, and scheduling substitute teachers to teach at a school, just to name a few.

1. Real Estate Showings

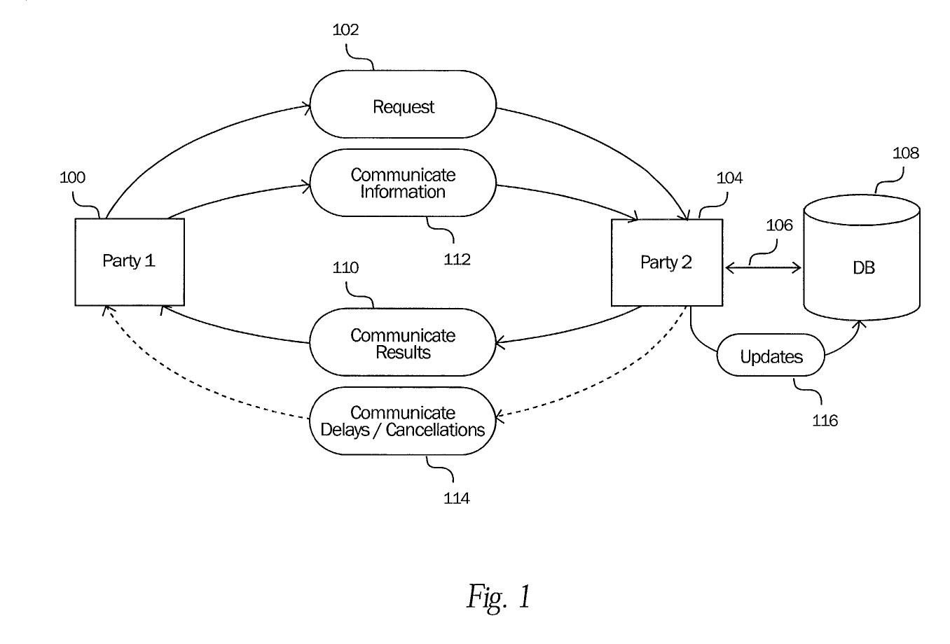

Real estate transactions typically involve the use of real estate agents to set up and coordinate real estate showings and sales. The seller of a property uses a listing agent to act as an agent to organize and facilitate the sale of the property. Potential buyers also use agents to set up showings and to facilitate the purchase of a property. Throughout this specification, an agent for a potential buyer who shows property to the buyer will be referred to as a “showing agent” or a “showing realtor.” Such a showing agent typically works for a real estate broker, which will be referred to as a “showing office.” Similarly, a “listing agent” or “listing realtor,” who typically works for a real estate broker referred to as a “listing office,” is an agent for the seller of the property. The term “seller” will be used in the specification to refer to the actual seller or occupant of the property and, more broadly, to the listing agent (or listing realtor) who acts as an agent for the seller. Similarly, the term “buyer” will be used in the specification to refer to the actual potential buyer of the property and, more broadly, to the showing agent (or showing realtor) who acts as an agent for the potential buyer. Thus, the showing agent, showing office, and buyer can be compared to “Party 1” in FIG. 1, and the listing agent, listing office, and seller can be compared to “Party 2” in FIG. 1.

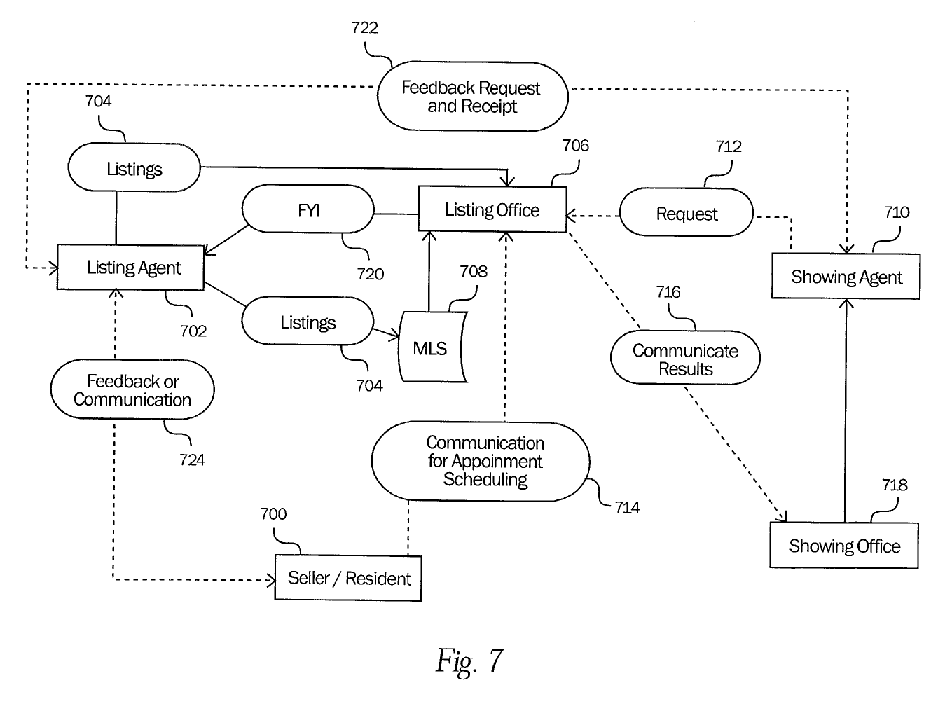

FIG. 7 illustrates the typical appointment process used in the prior art to set up an appointment for a showing agent to show a property to a potential buyer. A seller 700 uses a listing agent 702 to submit a listing 704 to the listing office 706 of the listing agent 702 and to the multiple listing service (“MLS”) 708. The MLS 708 is a database of listed properties commonly used by listing agents 702 to list properties and used by showing agents 710 to find property that may be suitable for a potential buyer, and can be compared to the database 108 of FIG. 1. After a showing agent 710 finds a suitable property listing from the MLS 708, the showing agent 710 requests 712 from the listing office 706 an appointment time by telephone to view and show the property. Such a request 712 may be for a specific time or may be an open-ended request for a suitable time from the seller 700. An agent or staff member at the listing office 706 then communicates 714 with the seller 700, typically over the telephone, to determine if the requested showing time is acceptable to the seller 700. The seller's message is then communicated 716 from the listing office 706 to the showing office 718, and the listing office 706 will also let the listing agent 702 know of scheduled showings (numeral 720).

After a property is shown to a potential buyer, the showing agent 710 is typically required to give feedback 722 to the listing agent 702 about the property. Such feedback 722 typically occurs over the phone. The listing agent 702 may also communicate 724 with the seller 700, sharing information about the property and deciding what further steps may be taken to facilitate the sale of the property.

a. Overview and Equipment

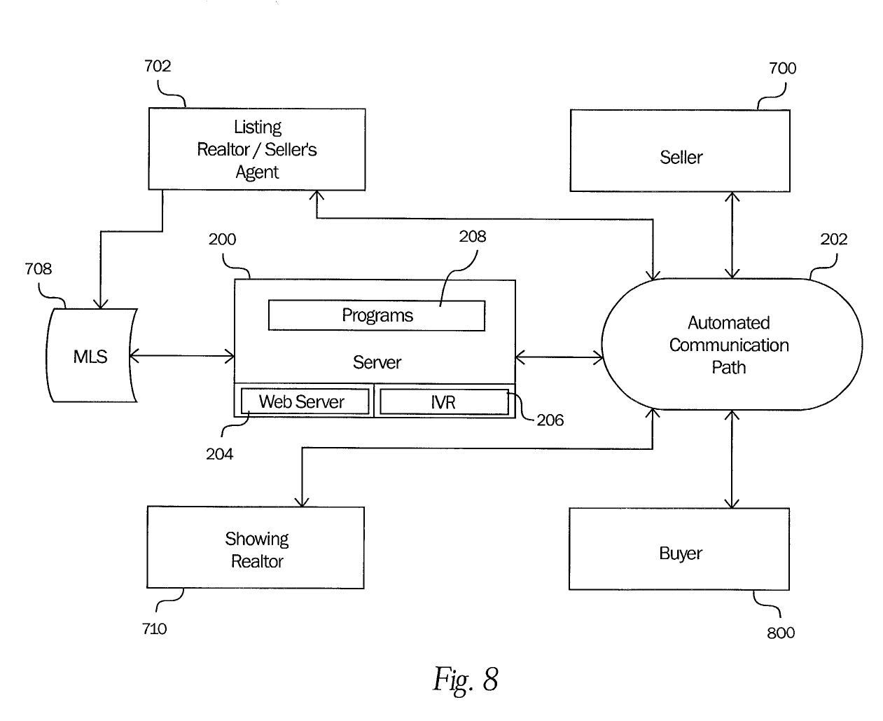

FIGS. 8-14 show an embodiment of the present invention. FIG. 8 shows one embodiment of the environment of the invention. In this embodiment, the database 108 is represented by the MLS 708, the first party 100 is represented by a buyer 800, a showing office 718 and a showing agent 710, and the second party 104 is represented by a seller 700, a listing office 706, and a listing agent 702. In this embodiment, an appointment server 200 communicates with one or more listing realtors 702, showing realtors 710, and sellers 700 over communication path 202.

The MLS 708 may also be used within the scope of the invention, although the MLS 708 may also be replaced entirely in one embodiment of the invention by the appointment server 200, which may contain real estate listings. In an embodiment using the MLS 708, the appointment server 200 may communicate with the MLS 708 to gather information about listings, and listings added through the appointment server 200 may also be communicated to the MLS 708 so that those listings are listed in the MLS 708. In some embodiments, the MLS 708 may be used for reference from the appointment server 200, such as by providing an Internet link to the MLS 708 from a web page in the appointment server 200. In another embodiment using the MLS 708, addresses and pictures of property, as well as other information, may be uploaded from the MLS 708 to the appointment server 200. The MLS 708, therefore, may be either integral with the appointment server 200 or a completely separate system that is used only for reference from the appointment server 200.

In the embodiment shown in FIG. 8, the appointment process for real estate transactions is automated. The appointment server 200 may include, either separately or as part of the same computer system, those components described in FIG. 2, such as a web server 204 and IVR system 206.

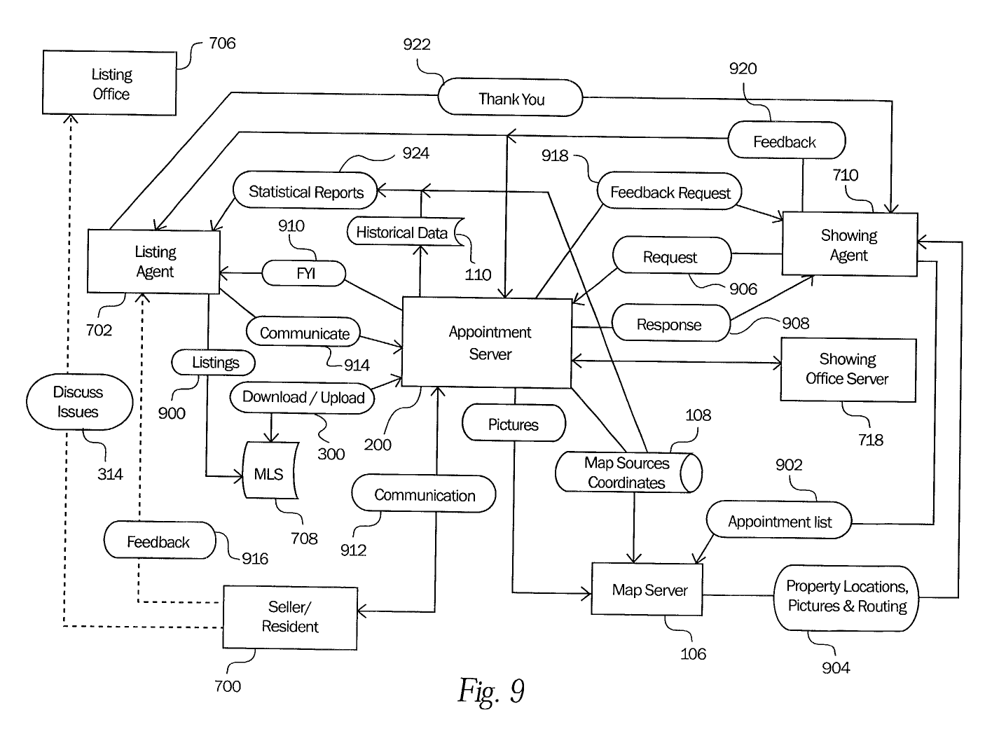

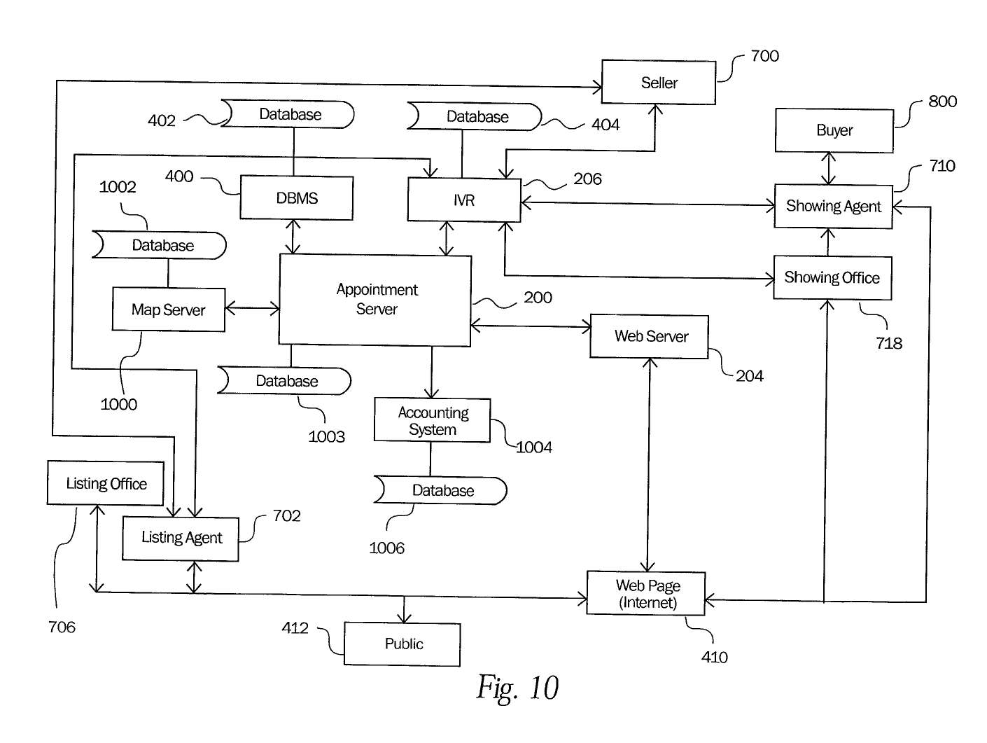

FIGS. 9 and 10 illustrate more detailed embodiments of the appointment server 200 of the invention. FIGS. 9 and 10 like FIGS. 3 and 4, illustrate that the appointment server 200 may contain a number of databases or servers, which may be either separate computers or computer systems from the appointment server 200 or applications or databases running on the appointment server 200. Like the embodiment shown in FIG. 4, in one embodiment, a database management server 400 and database 402 that stores listing information for listed properties, historical data, and other programs or information may be part of the appointment server 200. The IVR system 206 may have a server and database 404 to provide for the operation and data storage of the voice response system of the invention. In this embodiment, a map server 900 and database 902 may be used in one embodiment to access maps, geographic information, and directions to or from listed properties. An accounting server 904 and database 906 may be used to track listings, transactions, and service charges that may be incurred using the appointment server 200. The accounting server 904 and database 906 may also be used for the automated generation of bills that may be sent via e-mail, a Web application, or standard mail to a realtor. It is to be understood that the databases and servers described above may be used together or separately, may exist within the appointment server 200 or separately or at a remote site. As such, these databases and servers are separately listed only to illustrate that a number of components to the appointment server 200 may exist. In addition, the system and method of the invention may coordinate in uploading and/or downloading information from the MLS 708, as shown in FIGS. 8 and 9 (numeral 316 of FIG. 9).

The web server 204 or IVR system 206 may be set up so that only realtors 702, 710 have access thereto, via either password protection or secured communications paths, although full or partial access may be given to buyers 800 and/or sellers 700 in other embodiments. The references to listing realtor 702, seller 700, and showing realtor 710 in the Figures may refer to the person himself or herself and/or to the computer, computer system or telephone system used by that person for communication through the communication path 202. The web page 410 operated by the web server 204 may have portions that are available generally to the public 412, such as open house showings and maps to those showings, as well as portions that may be accessed only by agents with accounts. The web site may also have information such as online purchasing agreements and the like for purchase or use, brochures or riders for advertising purposes, and links to other web sites that contain valuable information.

In one embodiment, a showing realtor 710 may communicate with the appointment server 200 and request an appointment to show a property using either IVR, as is well know in the art, or using the Web. In the common situation in which the seller 700 of the property will not allow the property to be shown at any time, the appointment server 200 may automatically communicate with the seller 700, typically through the phone but possibly through e-mail or the Web, to request authorization to show the property. After the appointment server 200 has received a response from the seller 700, the response may be automatically communicated to the showing realtor 710, the listing realtor 702, and the listing office 706. In addition, records of requests for showings, showings that are actually set up, and records for other information may be saved in the appointment server 200 so that the records may be used for statistical or business purposes. The feedback process may also be automated by having the appointment server 200 automatically send an e-mail or other request to the showing realtor 710 requesting general or specific information about the showing. These and other features of this embodiment of the invention will be discussed further in the following section.

b. Operation of the Real Estate Embodiment

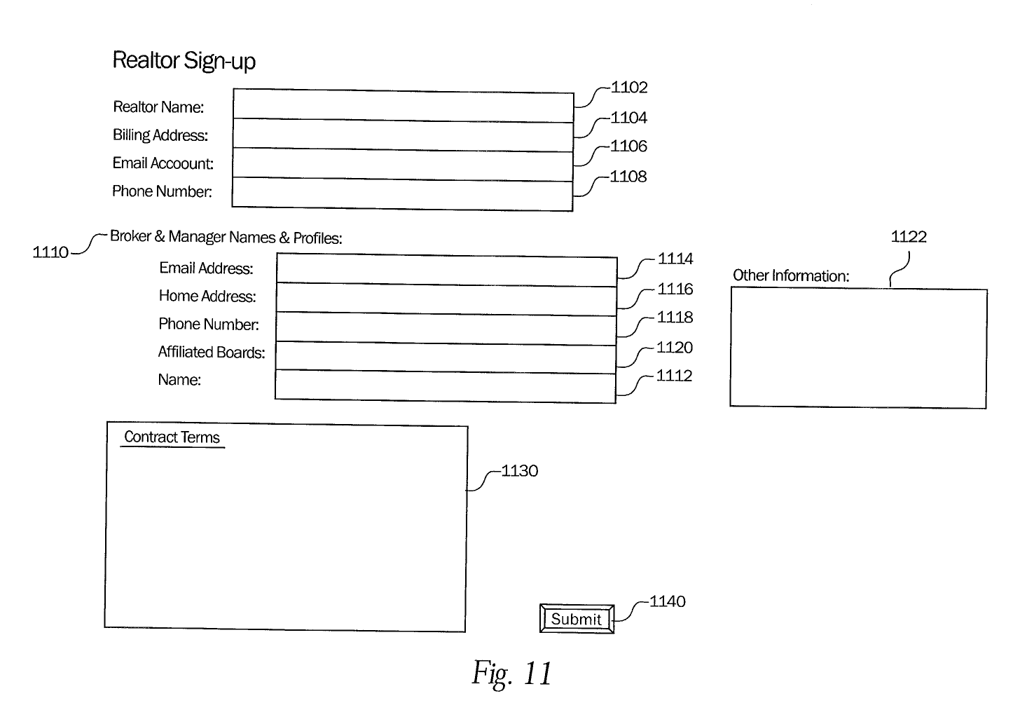

FIGS. 8-10 are block diagrams illustrating embodiments of the system and operation of the invention. FIGS. 11-12 and 14 illustrate potential web pages or database entries that may be used in the operation of the invention. The data listed in FIGS. 11-12 and 14 may be stored in the appointment server 200 of the invention or in the various servers and databases depicted in FIGS. 9 and 10. Although numerous data types are listed in each of FIGS. 11-12 and 14, the invention may function with any subset of the data in the given Figures, such that each type of data is not required for the invention to function.

i. Compiling Broker Information in the Appointment Server

Real estate agent offices, which include both listing offices 706 and showing offices 718, may enroll with a system proprietor of the appointment server 200 by providing certain information. FIG. 11 depicts one embodiment of information that may be requested from real estate agent offices to sign up with the appointment server 200. A web page such as that shown in simplified form in FIG. 11, may be used to gather the information, and any variety of data entry methods or systems, including drop down boxes, tab folders, and on and off buttons, used by those skilled in the art may be used to gather the information.

The data listed in the embodiment of FIGS. 11-12 and 14 may be stored in the appointment server 200 of the invention or in the various servers and databases depicted in FIG. 10. Although numerous data types are listed in each of FIGS. 11-12 and 14, the invention may function with any subset of the data in the given Figures, such that each type of data is not required for the invention to function.

In the real estate embodiment, FIG. 11 illustrates that information for realtors may include the realtor name 1102, billing address 1104, an e-mail address 1106, and a phone number 1108, and any other general information about the real estate office. A member identification number (“MIN”) may also be used along with a password for each realtor and/or agent for security purposes. Specific information 1110 for each broker, agent, or manager of the real estate office may be collected. Such information may include the realtor's name 1112, e-mail address 1114, home address 1116, phone numbers 1118 (which may include home, work, cell, and pagers), and affiliated boards 1120, such as the National Association of Realtors and/or state and local real estate boards. Other information 1122, including but not limited to web address and billing address and MINs, may also be collected for each agent. Contract terms 1130 for the realtor's enrollment with the appointment server 200 may be printed on an enrollment web page or on forms. Such contract terms 1130 may include waivers for errors in setting up showing appointments, fee agreements, and other contract terms for the engagement. In a web embodiment, a submit 1140 or other button may be present to allow for the submission of the information to the appointment server 200. In one embodiment, the realtor may also submit information regarding the types of property the realtor is looking for, and the appointment server 200 may automatically notify the realtor (by e-mail, the Internet, or otherwise) when a listing meeting the realtor's requirements is entered into the appointment server 200.

Real estate offices may also log on to the appointment server 200 and check billing information for accounts, generate reports on property listings, modify listings for property, and perform other managerial functions for their accounts.

ii. Compiling Listing Information in the Appointment Server

A listing agent 702 or listing office 706 may submit a new listing or update an existing listing through the appointment server 200. In an embodiment using the MLS 708, listings submitted through the MLS 708 may be updated to the appointment server 200 on regular intervals so that the appointment server 200 has current information about the listing. Similarly, listings may be downloaded from the appointment server 200 to the MLS 708. FIG. 9 indicates the uploading or downloading of information between the MLS 708 and the appointment server 200 as numeral 316, and the submission of listings by the listing agent 702 to the MLS 708 as numeral 900. In addition, listings added directly by listing agents 702 to the appointment server 200 may be downloaded to the MLS 708 so that the MLS 708 has current information about those listings. In the event that listing information is uploaded from the MLS 708 to the appointment server 200 instead of added directly to the appointment server 200, the listing agent 702 may need to supply additional information, such as seller-specific information, to the appointment server 200 so that the method and system of the invention may operate. In such an embodiment, the appointment server 200 may send an e-mail to the listing agent 702 or seller 700 to request the information, or, in another embodiment, place an IVR phone call to request the information. It should also be understood that in one embodiment of the invention the MLS 708 may not be used, such that only those listings added directly to the appointment server 200 will be used in operation of the invention.

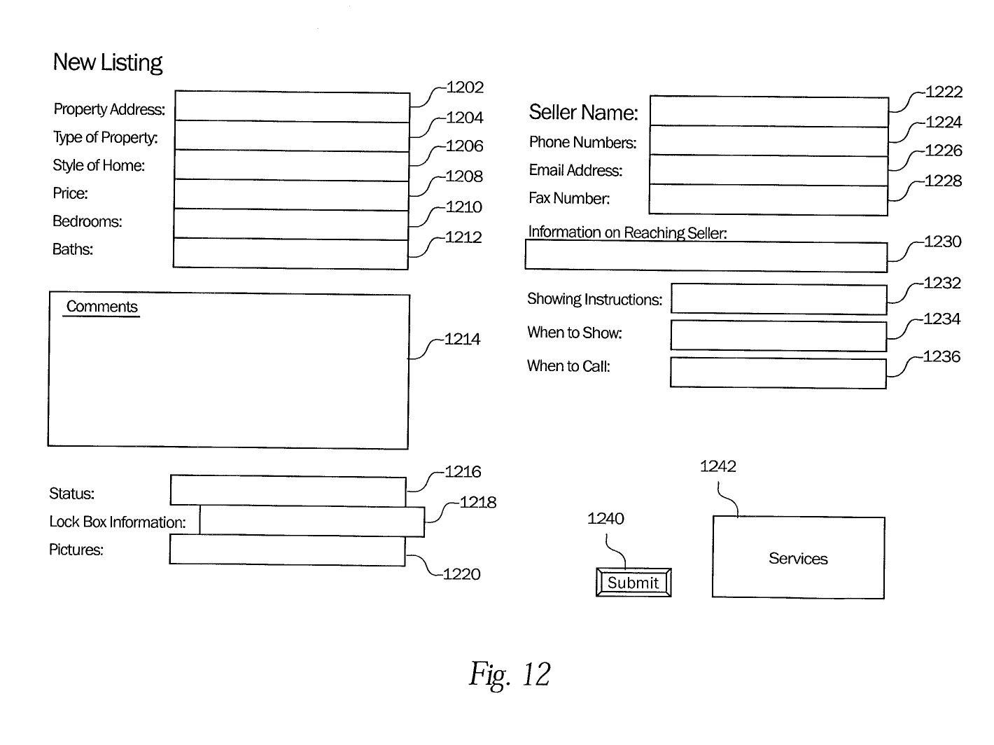

FIG. 12 illustrates some of the information that may be used for a new real estate listing. As the information shown in FIG. 11, this information may be requested in a web page or through other methods, and the discussion with respect to the information of FIG. 11 applies to the new listing information of FIG. 12 as well.

Basic information about a property for a new listing, such as the property address 1202, the type of property 1204, the style of home or property 1206, the price 1208, the number of bedrooms 1210, and the number of baths 1212, may be entered. In addition, the Property Identification Number (“PID”) for the property may be entered, which is generally assigned by the county of the property and identifies the property for several purposes, such as tax purposes. A description of any of these features may also be provided in one embodiment, and other comments 1214 about the home may also be provided. Information about the seller 700 may also be entered, such as the seller's name 1222, phone numbers 1224, and facsimile numbers 1228. Other information 1230 about reaching the seller 700, such as the best time 1236 to call the seller 700 or the location of the seller 700 at different times of the day, may also be entered. Specific or general showing instructions 1232 and times to show the property 1234 may also be entered. Lock box information 1218, which may, in one embodiment, be kept in a database separate from address information or seller information for security purposes, may be entered into the appointment server 200. Status information 1216, such as whether a listing is a new listing or otherwise, may also be entered. The appointment server 200 may automatically update status information if the listing remains on the system (updating the status from “new” to “on market” after a set period of time, such as 10 days, or listing a property as being sold). Pictures 1220, drawings, or other artistic representations of property may also be submitted. Finally, information about real estate related services 1242, such as loan information, may also be included for advertising purposes.

For each listing added to the appointment server 200, a map may be associated with the listing to aid potential buyers 800 and showing agents 710 in finding the property. The map may be a simple, low detailed map, or a higher detailed map of the area. The map may be generated automatically by the appointment server by using well-known on-line map sources, such as Mapquest, or by asking listing agents 702 to supply a map for inclusion in the listing record. In addition to a map showing the location of the property, directions from well-known cities, landmarks, locations, highways, or roads may be included to aid in showing the property. In one embodiment, the maps may be large enough and detailed enough for use in a vehicle when driving to or between listings. The directions may also be provided by on-line sources or by the listing agent 702 himself or herself when listing the property.

In one embodiment, a listing added by a listing agent 702 is not immediately available to all showing agents 710. Instead, the availability of the listing to all showing agents 710 is delayed by a distribution delay factor so that only listing agents 702 from the listing office 706 of the listing agent 702 who added the listing will have immediate access to the listing. This allows agents from the listing office 706 of the listing agent 702 who added the listing to have the first opportunity to sell the property. The distribution delay factor can be any amount of time, such as from one hour to two weeks. After the period of the distribution delay factor is up, the listing will be generally available to all listing agents 702.

After real estate brokers have registered with the appointment server 200, the server may be used to find property with specific characteristics and to arrange for a showing of the property.

iii. Setting Up Appointments to Show Property

1. Searching for Property

The appointment server 200 may contain a web page that allows for searching for property by showing agents 710 or, in another embodiment, by potential buyers 800. The web page may be any type of web page known to those skilled in the art and may use any known searching software or technique. A showing agent 710 may be required to log on to the web site, which may require password control, prior to searching for property. Searches may be conducted by any data type contained in the listing information, such as searches by area code, city, property type or style, price range, number of bedrooms, or number of baths. In one embodiment, searches conducted through the appointment server 200 may search through the MLS 708 for property and display partial or entire records for any listings in the MLS 708 that are not included in the appointment server's 200 records. Through the use of a single appointment server 200, or through a networked group of appointment servers 200, showing agents 708 from many real estate offices can arrange for showings of property. Alternatively, the search may be conducted on another web site, such as the broker's web site or the MLS web site, and then be linked to the appointment server web page via web link carrying parameters that identify the property or properties selected and process to schedule the appointments on the appointment server web page, then returning to the original web site.

After a search has been conducted, the showing agent 710 may view records for the property listing retrieved in the search. The records may contain all or a portion of the information depicted in FIG. 12, and the record may be displayed with pictures of the property, a map of the location, and directions to the location from nearby highways, roads, cities, or landmarks.

The showing agent 710 may next request those listings that he or she desires to show to a potential buyer 800. After the showing agent 710 selects those listings, the appointment server 200 (and more specifically the map server 1000) may generate a map showing the location of each listing (with a number, letter, or otherwise). The map may also contain directions for the showing agent 710 so that the showing agent's 710 route from property listing to property listing is defined. In another embodiment, a map with each retrieved listing may be displayed to the showing agent 710, and the showing agent 710 may be allowed to select a desired order to show the listings. FIG. 9 indicates requests for map information for appointment lists as numeral 902 and a response with map information from the appointment server 200 as numeral 904. After the showing agent 710 has reshuffled the listings into a desired order for showing, a map may be depicted that shows the locations of the listings, a route to show the listings, and directions to get from one listed property to the next. The map and directions may be printable so that the showing agent 710 can use the map and directions for showings. In an embodiment where only showing agents 710 and not potential buyers 800 have access to the appointment server 200, the maps and directions may be e-mailed or copied and electronically forwarded to potential buyers 800 so that the potential buyers 800 can see the locations of property and drive between properties themselves. A potential buyer 800 may also wish to view the properties himself or herself prior to scheduling a showing, and the potential buyer 800 may therefore eliminate certain properties prior to scheduling an actual showing.

Certain information about property listings may be contained on a report that is for a showing agent's eyes only. Such information includes lock box combinations, showing instructions, and other pertinent information.

A variety of other information may be presented to a showing agent 710 when results from a search are presented. Such information may include a color scheme showing the status of each listing (new, old listing, etc.), flags to indicate listings with open houses scheduled, a listing showing available times for showings, and whether multiple showings are allowed for the listing.

2. Scheduling Showings

Showings may be automatically scheduled for property listings through the appointment server 200 in one embodiment of the invention. In the event that a showing agent 710 wishes to show more than one listing on a tour, scheduling may take place prior to the generation of a map (described above) for the showing agent 710, so that the showing agent 710 can have confirmed showing times prior to generation of a map and directions between showings. It should be noted that listing agents 702 and showing agents 710 may continue to communicate with sellers 700 and potential buyers 800 via telephone or other methods to keep professional relationships alive and to discuss steps to be taken to purchase property or to sell listed property.

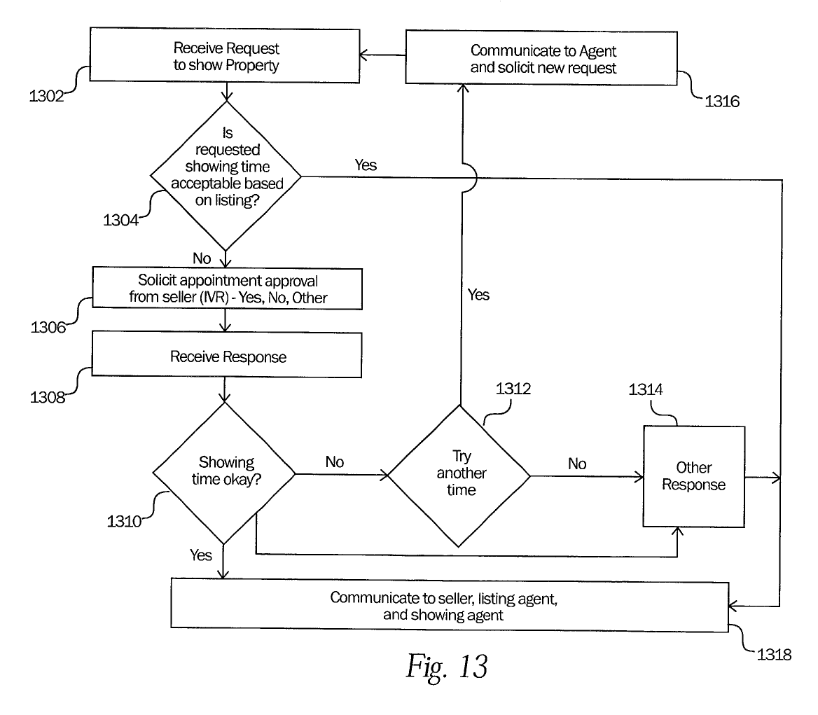

FIG. 13 is a flow chart of one embodiment of the scheduling and appointment process of one embodiment of the invention, and FIG. 9 also depicts communications used in an embodiment of the invention. A showing agent 710 may request to show a property listing at a certain time, as depicted by numeral 906 in FIG. 9. As shown in FIG. 13, the appointment server 200 receives this request (block 1300). In some listings, a seller 700 may indicate that certain times are acceptable for showings and that only notification is required to the seller 700. The appointment server 200, therefore, may query whether the requested showing time is acceptable based on the listing record (block 1302). If the showing time is acceptable, the showing agent 710 will be notified (via the Web, e-mail, or telephone or IVR), and notification may be sent to the showing agent 710, listing agent 702, listing office 706, and showing office 718 (FIG. 13, block 1316; FIG. 9, numerals 908, 910, and 912). FIG. 9 also depicts communication between the listing agent 702 and the appointment server 200 for clarification or further information as numeral 914. When the showing agent 710 is notified that the showing time is acceptable, the notification (Web, e-mail, telephone, or IVR) may include any combination of the following pieces of information, which may be accessed from the appointment server 200 or a database 1003 attached thereto: the lock box combination for the home, special showing instructions, and security issues for the home. In this embodiment, the showing agent 710 may be automatically provided with all of the information that is necessary for a property showing. In one embodiment, only a showing agent 710 with a MIN can access a web page or IVR messages that include responses from sellers 700 of property to requests to show property, so the lock box combination and other confidential information may be kept secure.

In the event that the showing time is not automatically acceptable based on the listing record, the appointment server 200 may place a call, via the IVR system 206, to the seller 700 to solicit appointment approval (FIG. 13, block 1304; FIG. 9, numeral 912). The solicitation to the seller 700 may ask for a voice or touch-tone response indicating that the time is acceptable, not acceptable, or asking for some other response. If the showing time is acceptable (block 1308), this information may be automatically communicated to the one or more of the listing agent 702 and showing agent 710, as well as to the listing office 706 and showing office 718 (some realty boards require appointment confirmation with a showing office 718 and not just with a showing agent 710). Information, such as the lock box combination, may also be provided to the showing agent 710 as discussed above.

If the showing time is not acceptable and the showing agent 710 should try another time (block 1310), a message may be sent via e-mail, telephone, or the Web to the showing agent 710 to communicate the seller's response and to solicit a new request to show the property (block 1314). If the seller 700 has some response other than yes or no or try another time (block 1312), such as a need to talk with the listing agent 702, this message may be automatically communicated to the listing agent 702 and/or showing agent 710. In an embodiment in which the appointment server 200 contains a list of available times for showings in the listing for a property, the list of acceptable times may be provided to the potential buyer 800 or showing agent 710 in response to a request for a showing (if the requested showing time is not acceptable). The listing agent 702 may then contact the seller 700 via traditional methods to resolve issues relating to showing the property and, in one embodiment, the listing agent 702 or the seller 700 may phone in through the IVR system 206 (or enter via the web site) a response to a request to show property. In the event that the showing agent 710 is using the Web to request showing times, the response from the seller 700 may be received through the Web in a matter of moments and, if a response from the seller 700 is not received within a threshold time period, a message may be displayed to the showing agent 710 to indicate that a response will be posted later or that the showing agent 710 will be notified via IVR, e-mail, or otherwise.

In one embodiment, information for listing agents and offices 702, 706, such as scheduled or attempted showings and requests to contact the seller 700, may be communicated via the IVR system 206 or via e-mail. In another embodiment, information for listing agents 702 or listing offices 706 may be compiled in the appointment server 200 for presentation over the Web. In such a situation, the listing agent 702 may log on to the web site at a convenient time and check the status of specific listings to determine whether showings have been scheduled or attempted and to determine if there have been requests to contact the seller 700. Market intelligence and statistical reports may also be made available to the agents in such an embodiment.

A showing agent 710 may, in one embodiment of the invention, request multiple showing times for different property listings based on search results of property listings through use of either the web server 204 of the appointment server 200 or through the IVR system 206. The showing agent 710 may then log off the web site (or hang up the phone), and then check to determine the status of the requested showings by phone or through the web site at a later time. The showing agent 710 may therefore arrange for several property showings at one time, in effect setting up a “tour” of property showings. After the showing agent 710 receives the results, the showing agent 710 may request different showing times (depending on the seller's 700 response or changed circumstances) and then print a schedule and map for showings. In other embodiments, the map for the showings may be displayed and the showing agent 710 may click on listings to delete the listings or modify the showing times. For instance, if a desired showing time for one property is not available, a different showing time may be needed for a number of the properties of the tour. The appointment server 200 may assign an identification code to the tour, and, depending on the results of the requests for showings, the showing agent 710 may recall the tour and modify requested showing times or properties without having to re-enter all of the information for the desired showings a second time. The showing agent 710 may also change requested showing orders or dates. After the showing agent 710 has found an acceptable tour in terms of available showing times, maps (showing directions between showings) and any other information needed for a showing, such as lock box combinations and showing directions, may be provided to the showing agent 710 for each home as discussed above. In many situations, seller's 700 are communicated with by the appointment server 200 quickly and a response from the seller 700 to the requested showing is received by the showing agent 710 in a matter of minutes or even seconds.

The appointment server 200 may, in one embodiment, notify the listing agent 702 or listing office 706 by e-mail or IVR when the seller 700 does not agree to a requested showing time or if the seller 700 has some response other than yes or no to a requested showing time. The listing agent 702 may then speak with the seller 700, as indicated by numeral 916 in FIG. 9, to discuss and resolve issues related to showing the property.

iv. Gathering Feedback After Property Showings

After a property has been shown by a showing agent 710, the appointment server 200 may automatically request feedback from the showing agent 710, as indicated by numeral 918 in FIG. 9. To automatically request this feedback, the appointment server 200 may simply request the feedback the day of the showing or the day after a showing was scheduled. The feedback may be requested by IVR, web page forms, or by e-mail. After the feedback has been received by the appointment server 200 from the showing agent 710, the feedback may be automatically communicated by e-mail or otherwise to the listing agent 702 (numeral 920 of FIG. 9). In another embodiment, the feedback request may be directed to the showing agent 710 but then sent via e-mail directly to the listing agent 702. The listing agent 702 may then communicate feedback and other information to the seller 700 of the property via traditional methods to ensure that a personal and professional relationship is maintained. FIG. 9 also depicts a thank you message 922 that may be sent from the listing agent 702 to the showing agent 710 after feedback has been received by the listing agent 70.

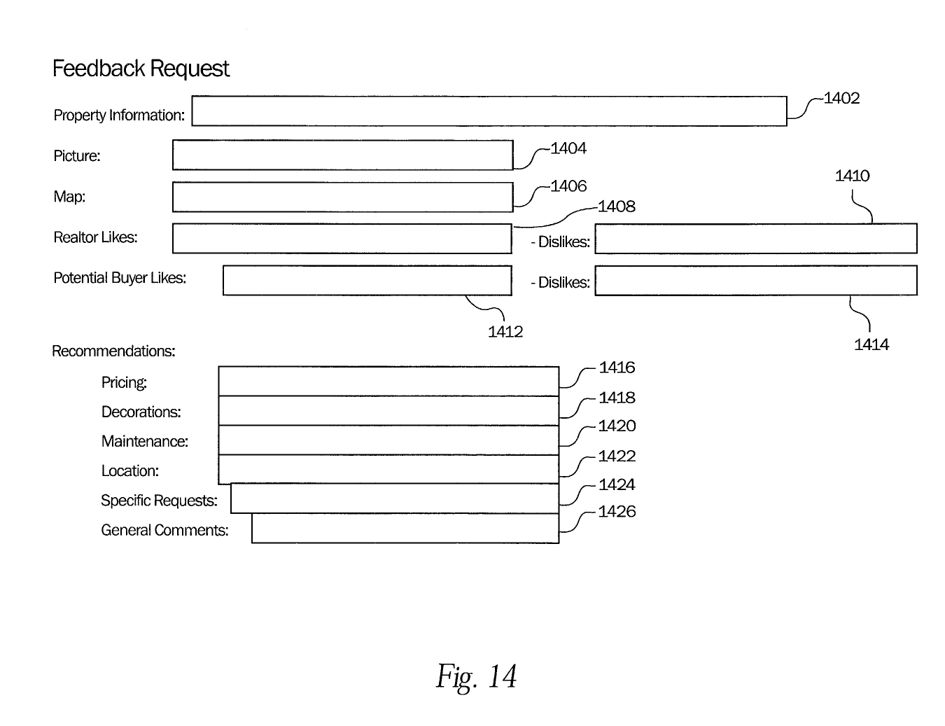

One suitable feedback request that may be sent via e-mail to a showing agent 710 is shown in FIG. 14. FIG. 14 illustrates one possible form of a feedback request, and such a request could also be solicited using an IVR system or through a web page. FIG. 14 indicates that the feedback request may contain property information 1402 (such as an address, the style of the home, and the price, among other types of information) so that the showing agent 710 will recognize the property, as well as a picture 1404 of the property and a map 1406 showing the location of the property. The feedback request may solicit information on the realtor's likes 1408 and dislikes 1410, as well as the potential buyer's 800 likes 1412 and dislikes 1414. As with the other web pages or e-mails described in this specification, any variety of data solicitation and entry methods and systems known to those skilled in the art, such as data entry boxes, drop down boxes, and the like, may be used for the feedback request. The feedback request may also include a section for recommendations, including recommendations on pricing 1416, decorations 1418 of the property, maintenance 1420, and location 1422, and whether the location of the property was properly indicated on maps generated by the appointment server 200. The feedback request form may also contain a section for specific requests 1424 that the listing agent 702 or seller 700 desires to be solicited, and a section for general comments 1426.

V. Mining Information for Property

Listing agents 702 (or possibly a showing agent 710, the seller 700, or a potential buyer 800) may check on the status of listed properties or view historical information through the appointment server 200. FIG. 9 depicts the availability of such statistical reports and information as numeral 925. Statistical information may be kept regarding how often a particular listing has been retrieved as relevant to a showing agent's 710 search, how many requests to show the listing have occurred, how many actual showings have occurred, how many showings have been canceled, and other information that may be relevant to the ability of the property to be sold. Because prior art methods and systems have no direct route of tracking this information, the system and method of the invention may aid sellers 700 and listing agents 702 in selling property. Such information may be available through web pages within the appointment server 200, such that some web pages contain specific types of information for a property listing and other web pages contain information about the market as a whole, for instance, the number of homes sold or shown in a particular price range.

The web site of the appointment server 200 may provide a center for information for sellers 700 and showing agents 710 that contains feedback information from showings, statistical information as described above for particular listings, and market activity. Such information may be viewed in yearly, monthly, weekly, or daily periods. Numerous types of information may be made available, including market activity trends pertaining to a particular style or price of property, showing activity for a listed property compared with activity for other similar listings, geographic distribution information for listings, and showing and sales information for particular realtor offices and for the market as a whole. In addition, other information may be provided, such as market activity with respect to the calendar time of the year.

Other possible data mining features include online search capabilities for open houses that meet certain selection criteria, along with mapping information, as described above, for those open houses. Potential buyers 800 may be profiled and certain listed properties may be suggested as falling within categories (i.e., price, location, number of bedrooms) that such a profiled buyer 800 may be interested in. Another possible feature is the profiling of property along with the actual buyers 800 of the property in an effort to determine if certain classes of products and/or services are likely to sell to those purchasers. Information regarding buyers 800 may then be provided to vendors of products and/or services so that sales efforts may be made to the buyer 800.

The appointment server 200 may have automated accounting and billing systems, denoted as numeral 1004 and 1006 in FIG. 10, to automate the collection of billing information for the appointment server 200. The proprietor of the appointment server 200 may charge realtors (listing agents 702, listing offices 706, showing agents 710, and showing offices 718) based on usage of the appointment server 200. The appointment server 200 may, in one embodiment, charge showing agents and offices 710, 718 based on searches for property, scheduled showings, calls made to and from the IVR system 206, and based on usage of other features of the invention. In addition, listing agents and offices 702, 706 may be charged based on showings of listed property, listings of property with the appointment server 200, feedback submissions, or other usages of the appointment server 200. In other embodiments, showing agents and offices 710, 718 and listing agents and offices 702, 706 may be charged periodic fees, such as monthly fees, to use the appointment server 200. The accounting and billing systems 1004, 1006 of the appointment server 200 may track such billing information to automate accounting and billing procedures.

2. Scheduling Appointments at a Practitioner's Office

Another embodiment of the present invention, is the scheduling of appointments at a practitioner's office. In this embodiment, the term “practitioner” can mean any professional practicing entity, such as a doctor, a dentist, or a lawyer, and the term “client” can mean any party wishing to make an appointment, such as a patient or client. The prior art for the process of scheduling an appointment at a practitioner's office is similar to that described in FIG. 1. The first party 100 represents the client, the second party 104 represents the practitioner or a staff member at the practitioner's office, and the database 108 represents the practitioner's schedule.

The system and process for scheduling an appointment at a practitioner's office is similar to the system and process described above in FIGS. 2-6. The system can have the same general overview as that described in FIG. 2. The communications flow between the parties and the appointment server 200 and equipment of the appointment server 200 as used in an embodiment of the invention for scheduling an appointment at a practitioner's office, is described in FIGS. 3 and 4. The process for scheduling an appointment and the process for notification in case of a delay or cancellation for an embodiment of the invention for scheduling an appointment at a practitioner's office, is described in FIGS. 5 and 6.

A client can access an appointment server 200 either via a web server 204 or an IVR system 206, and can schedule an appointment. In one embodiment, the appointment server 200 can contain all of the practitioners for a given area, such as a city, state, region, or country. The client may then browse through the available practitioners and select from a group of practitioners or practitioner's offices. In one embodiment, after the client has selected the practitioner, the client can input all of the information needed for the appointment, such as insurance information, contact information, and reason for the appointment. After the client schedules the appointment, the appointment server 200 can send a message to the practitioner's office informing them of the appointment.

In one embodiment, the appointment server 200 can have different servers as described in FIG. 4. Some examples of servers that can be used in this embodiment are a map server that can show the client a map to the location of the appointment, or an accounting system as described in FIG. 10.

In one embodiment, the database 108 and the appointment server 200 can upload and download information between each other when new information is added to either one, or changed. In another embodiment, there is no database, and the practitioner's office can update the appointment server 200 with schedule changes or new appointments.

In one embodiment, if there is a delay or cancellation, the appointment server 200 can automatically contact all interested parties, either via the web server 204 or by using the IVR system 206. When scheduling appointments, clients may input different modes of communication, and may list a preferred mode of communication. If there is a delay or cancellation, the appointment server 200 can contact every interested party, saving the staff at the practitioner's office time, money, and effort, while still ensuring that a valid effort is made to relay the information.

The process and system can easily be used to arrange and confirm appointments among several parties. In this scenario, each party could be contacted and offered appointment time options to choose from. Once an appointment time is selected, the times selected by all of the parties can be merged, and the resulting common time can be communicated to all parties involved.

3. Making Reservations at a Restaurant or Hotel

Another embodiment of the present invention, is the scheduling of reservations at a restaurant or hotel. The prior art for the process of scheduling a reservation at a restaurant or hotel is similar to that described in FIG. 1. The first party 100 represents a patron, the second party 104 represents the restaurant or hotel, and the database 108 represents the restaurant or hotel's reservation schedule.

The system and process for scheduling a reservation at a restaurant or hotel is similar to the system and process described above in FIGS. 2-6. The system can have the same general overview as that described in FIG. 2. The communications flow between the parties and the appointment server 200 and equipment of the appointment server 200 as used in an embodiment of the invention for scheduling a reservation at a restaurant or hotel, is described in FIGS. 3 and 4. The process for scheduling a reservation at a restaurant or hotel and the process for notification in case of a delay or cancellation for an embodiment of the invention for scheduling a reservation at a restaurant or hotel, is described in FIGS. 5 and 6.

A patron can access an appointment server 200 either via a web server 204 or an IVR system 206, and can schedule a reservation. In one embodiment, the appointment server 200 can contain all of the restaurants or hotels for a given area, such as a city, state, region, or country. The patron may then browse through the available restaurants or hotels and select from a group of those listed. In one embodiment, after the patron has selected the restaurant or hotel, the patron can input all of the information needed for the reservation, such as number in the party, contact information, and smoking or room preferences. After the patron schedules the reservation, the appointment server 200 can send a message to the restaurant or hotel informing them of the reservation.

Alternatively, the patron could search for information on a separate web page, such as a restaurant's home page, and access the appointment server from a link from that web page.

In one embodiment, the appointment server 200 can have different servers as described in FIG. 4. Some examples of servers that can be used in this embodiment are a map server that can show the patron a map to the location of the reservation, or an accounting system as described in FIG. 10.

In one embodiment, the database 108 and the appointment server 200 can upload and download information between each other when new information is added to either one, or changed. In another embodiment, there is no database, and the restaurant or hotel can update the appointment server 200 with schedule changes or new reservations.

In one embodiment, if there is a delay or cancellation, the appointment server 200 can automatically contact all interested parties, either via the web server 204 or by using the IVR system 206. When scheduling reservations, patrons may input different modes of communication, and may list a preferred mode of communication. If there is a delay or cancellation, the appointment server 200 can contact every interested party, saving the staff at the restaurant or hotel time, money, and effort, while still ensuring that a valid effort is made to relay the information.

4. Making a Reservation on an Airline Flight

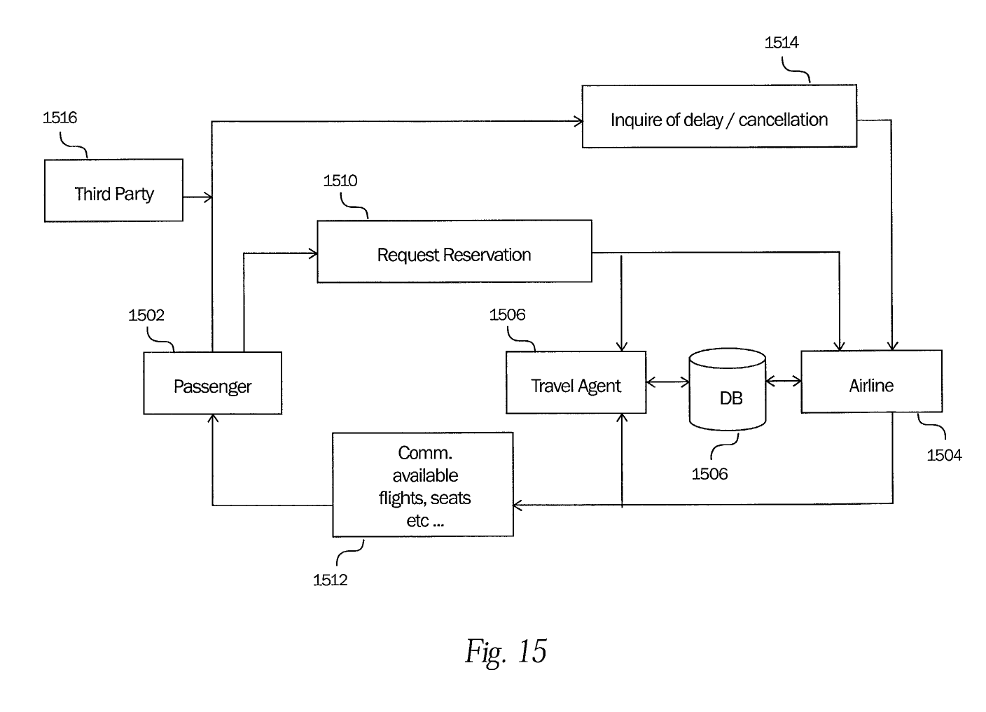

Another embodiment of the present invention, is the scheduling of reservations on an airline flight . FIG. 15 shows a typical reservation process for making a reservation on an airline. Like the process shown in FIG. 1, a passenger 1500 contacts an agent 1502, or an airline 1504, usually by telephone, to request a reservation 1506. The agent 1502 can be a travel agent at a remote location from the passenger 1500 and the airline 1504, or the agent 1502 can be a staff member of the airline 1504. Such a request 1506 may be for a specific destination, day or flight. The agent 1502 or airline 1504 has access to a database 1508, which lists available and unavailable flights and seats. The agent 1502 or airline 1504 communicates 1510 the available time slots back to the passenger 1500, whereupon the passenger 1500 reserves a seat on the desired flight. The agent 1502 or airline 1504 then receives 1512 and inputs the passenger's 1500 information, such as name, address, credit card number, etc., into the database 1508, reserving a seat on a flight. If a passenger 1500 wishes to check on the status of a flight prior to leaving for the airport, they must call 1514 a number at the airline 1504 to see if the flight has been delayed or cancelled. The airline 1504 does not contact the passengers 1500 to inform of any delays or cancellations.

Many times a third party 1516 picks up the passenger 1500 at the airport. Before leaving for the airport, the third party 1516 can call 1518 the airline 1504 to inquire as to the status of a certain flight.

The process of FIG. 15, has many of the same disadvantages as described above and shows some other disadvantages of the process. First, it forces the agent 1502 or airline 1504 to act as an unnecessary intermediary between the passenger 1500 and the database 1508 as described above. Second, many times, airlines are forced to delay or cancel flights due to weather or maintenance problems. If a flight is delayed or cancelled, the passenger 1500 is informed at the time they arrive at the airport for their flight, causing them to have either wasted an unnecessary trip to the airport, or arrive before they needed to. The only way for a passenger 1500 to be informed of the status of a flight is to communicate 1514, via telephone with the airline 1504. Only a call to the airline 1514 will inform the passenger 1500 of the flight's status. Also, many times the passenger 1500 on a flight is being picked up by a third party 1516 at the airport. The third party 1516 is not contacted in case of a flight delay or cancellation. This is typically not even possible, because airlines 1504 typically do not have contact information for third parties 1516. Only a call to the airline 1518 will inform the third party 1516 of the flight's status. Because of the amount of passengers 1500 on any given flight, and the number of third parties 1516 picking up various passengers, the airline 1504 cannot contact each person in case of a delay or cancellation. This would require many staff members spending a large amount of time making telephone calls.

The system and process for scheduling a reservation on an airline flight is similar to the system and process described above in FIGS. 2-6. The system can have the same general overview as that described in FIG. 2. The communications flow between the parties and the appointment server 200 and equipment of the appointment server 200 as used in an embodiment of the invention for scheduling a reservation on an airline flight, is described in FIGS. 3 and 4. The process for scheduling a reservation at a restaurant or hotel and the process for notification in case of a delay or cancellation for an embodiment of the invention for scheduling a reservation on an airline flight, is described in FIGS. 5 and 6.

A passenger can access an appointment server 200 either via a web server 204 or an IVR system 206, and can schedule a reservation. In one embodiment, the appointment server 200 can contain all of the airlines and flight information for a given area, such as a city, state, region, or country. The passenger may then browse through the available airlines and flights and select from a group of those listed. In one embodiment, after the passenger has selected the airline or flight, the passenger can input all of the information needed for the reservation, such as billing information, such as credit card information, contact information for both the passenger and any third party that may be picking up the passenger at the airport, and seat and class preferences. After the passenger schedules the reservation, the appointment server 200 can send a message to the airline informing them of the reservation.

In one embodiment, the appointment server 200 can have different servers as described in FIG. 4. Some examples of servers that can be used in this embodiment are a map server that can show the passenger or third party a map to the airport of departure or destination airport, or an accounting system as described in FIG. 10.

In one embodiment, the database 108 and the appointment server 200 can upload and download information between each other when new information is added to either one, or changed. In another embodiment, there is no database, and the airline can update the appointment server 200 with schedule changes or new reservations.

In one embodiment, if there is a delay or cancellation, the appointment server 200 can automatically contact all interested parties, including third parties either via the web server 204 or by using the IVR system 206. When scheduling reservations, passengers may input different modes of communication, and may list a preferred mode of communication, both for themselves and for any third party that may be picking them up at the destination airport. If there is a delay or cancellation, the appointment server 200 can contact every interested party, saving the staff at the airline time, money, and effort, while still ensuring that a valid effort is made to relay the information.

5. Scheduling a Substitute Teacher to Teach at a School

Another embodiment of the present invention is the scheduling of a substitute teacher to teach at a school. Like FIG. 1, there is a first party 100 (a school), a second party 104 (a substitute teacher), and a database 108 (the substitute teacher's schedule). In this embodiment, the school decides that they need a substitute teacher on a certain day. The school, through one of its staff members or officials goes through a list of different substitute teachers, and contacts different teachers to inquire as to availability and willingness to teach a certain subject at a certain time at a certain school. Some substitute teachers teach only at one school, but others are available to every school in a district or city. Once the school reaches a substitute teacher, that substitute teacher accesses their schedule to see if they are available. If the substitute teacher is available, the school will schedule the substitute teacher to come in and teach at the school.

Alternatively, substitute teachers can be the first party 100 and the school can be the second party 104. In this embodiment, teachers can use the appointment server web page or a separate web page, to search for available classes that fit their skills and/or schedules, and can sign up to teach those classes. Teachers may also sign up with the system, listing information, such as their skills, types of classes they wish to teach, and available schedule. This would be similar to a property watch in an embodiment of the present invention being used in a real estate setting. When a teaching opportunity arises that the server would decide is a good fit, the system can contact the teacher and allow them to sign up to teach the class.

The system and process for scheduling a substitute teacher to teach at a school is similar to the system and process described above in FIGS. 2-6. The system can have the same general overview as that described in FIG. 2. The communications flow between the parties and the appointment server 200 and equipment of the appointment server 200 as used in an embodiment of the invention for scheduling a substitute teacher to teach at a school, is described in FIGS. 3 and 4. The process for scheduling a substitute teacher to teach at a school and the process for notification in case of a delay or cancellation for an embodiment of the invention for scheduling a substitute teacher to teach at a school, is described in FIGS. 5 and 6.

A school can access an appointment server 200 either via a web server 204 or an IVR system 206, and can schedule an appointment. In one embodiment, the appointment server 200 can contain all of the available substitute teachers for a given area, such as a city, state, region, or country. The school may then browse through the available substitute teachers and select from a group of those listed. In one embodiment, after the school has selected the substitute teacher, the school can input all of the information needed, such as the name and location of the school, contact names and information, date needed to teach, time needed to teach, subject(s) needed to teach, and any specific relevant information necessary. After the school schedules the substitute teacher, the appointment server 200 can send a message to the teacher informing them.

In one embodiment, the appointment server 200 can have different servers as described in FIG. 4. Some examples of servers that can be used in this embodiment are a map server that can show the parties a map to the location of the school, or an accounting system as described in FIG. 10.

In one embodiment, the database 108 and the appointment server 200 can upload and download information between each other when new information is added to either one, or changed. In another embodiment, there is no database, and the substitute teacher can update the appointment server 200 with schedule changes.

In one embodiment, if there is a delay or cancellation, the appointment server 200 can automatically contact all interested parties, either via the web server 204 or by using the IVR system 206. When scheduling a substitute teacher to teach at a school, the parties may input different modes of communication, and may list a preferred mode of communication. If there is a delay or cancellation, the appointment server 200 can contact every interested party, saving the parties time, money, and effort, while still ensuring that a valid effort is made to relay the information.

### IV. Summary

The method and system of the invention provide numerous advantages over the prior art. The method and system benefits first 100 and second parties 104 by providing for timely and automated appointment scheduling. The first and second parties can be multiple parties, such as buyers/sellers and their agents. First parties 100 also benefit from the searching capabilities and mapping features of the invention that allows them to quickly and easily search for information on specific items, determine where the businesses or offices are located, schedule appointments or reservations, and generate maps and further information about the those information items.

Parties benefit from the system and method of the invention in that the appointment scheduling is automated so that human interaction from the may not be necessary to schedule appointments or reservations. This decreased human intervention is not only convenient for the second party 104, but it saves in labor costs that prior art methods and systems require. Second parties 104 may be able to conduct business more efficiently through the method and system of the invention, and labor-intensive desk activities may be removed.

The automated method of contacting parties in the case of a delay or cancellation is also beneficial to both parties. Contacting a party of a cancellation or delay saves that party an unneeded trip, and allows them to change their schedule accordingly. The automated method of contacting a party is especially superior over the prior art where a third party is contacted regarding the delay or cancellation, such as where a third party picking up an airline passenger is contacted when a flight is late. Removing the need to contact a party saves the canceling or delaying party much time and effort. This is especially so where many parties need to be contacted, such as in the case of a flight cancellation.

Both parties benefit from the automated feedback requesting and reporting features of the invention. A feedback request may be automatically sent to the first party 100 from the appointment server 200 so that the first party 100 only has to take a few minutes to fill out and submit the feedback form at a convenient time. In addition, specific requests for feedback may be included in feedback requests, and, in one embodiment, responses to certain queries in feedback requests may be required for submission of a response to the feedback request. The automated feedback feature of the invention, therefore, not only simplifies the feedback process, but it allows for the collection of more detailed and more specific information from appointments and reservations that may allow a second party 104 to adjust pricing, features, or presentation in order to complete a sale.

The feedback features of an embodiment of the invention may also provide industry uniformity and standards for the feedback process. In one embodiment, certain standard queries may be used for all information item listings, and specific queries may be used for particular listed items.

Potential first parties 100 may be able to locate item listings easier than in prior art methods and systems, and mapping features aid in carrying out appointments or reservations. Second parties 104 may be aided by simplified appointment scheduling, information mining on scheduled and actual appointments or reservations, and by the automated feedback mechanism of the invention.

The accompanying Figures described above depict embodiments of the present invention, and features and components thereof. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, a 8051 processor, a MIPS® processor, a Motorola Processor, a Power PC® processor, or an ALPHA® processor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

The system and method of the invention may use the “World Wide Web” (“Web” or “WWW”), which is that collection of servers on the Internet that utilize the Hypertext Transfer Protocol (“HTTP”). HTTP is a known application protocol that provides users access to resources, which may be information in different formats such as text, graphics, images, sound, video, Hypertext Markup Language (“HTML”), as well as programs. Upon specification of a link by the user, the client computer makes a TCP/IP request to a Web server and receives information, which may be another “Web page” that is formatted according to HTML. Users can also access other pages on the same or other servers by following instructions on the screen, entering certain data, or clicking on selected icons.

Servers run on a variety of platforms, including UNIX machines, although other platforms, such as Windows 95, Windows NT, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, HTTP allows for the transmission of certain information from the client computer to a server. The server can then post this information on its web site, forward it on to another user or server, or save it to a database for later use.

While the present invention has been described with reference to several embodiments thereof, those skilled in the art will recognize various changes that may be made without departing from the spirit and scope of the claimed invention. Accordingly, this invention is not limited to what is shown in the drawings and described in the specification but only as indicated in the appended claims, nor is the claimed invention limited in applicability to one type of computer or computer network. Any numbering or ordering of elements in the following claims is merely for convenience and is not intended to suggest that the ordering of the elements of the claims has any particular significance other than that otherwise expressed by the language of the claims.

1. A method for scheduling an appointment, the method comprising:
(a) receiving appointment availability information from a second party;
(b) receiving an appointment request from a first party;
(c) comparing the request to the availability information;
(d) automatically scheduling the appointment if the request is for an available time based on the availability information; and
(e) automatically updating the appointment availability information to reflect the appointment.

2. The method of claim 1, further comprising verifying the appointment with the first party.

3. The method of claim 1, further comprising automatically prompting another request if the request is for an unavailable time based on the availability information.

4. The method of claim 1, further comprising requesting contact information from the first party.

5. The method of claim 4, further comprising automatically contacting the first party if there is any change in the appointment.

6. The method of claim 1, wherein the first party is a passenger, the second party is an airline, and the appointment is an airline reservation.

7. The method of claim 6, further comprising receiving third party contact information, wherein the third party transports the first party to a departure airport or from a destination airport.

8. The method of claim 7, further comprising automatically sending information to the third party via email, fax or IVR.

9. The method of claim 1, wherein the first party is a patron, the second party is a restaurant, and the appointment is a dining reservation.

10. The method of claim 1, wherein the first party is a patient, the second party is a practitioner, and the appointment is an office appointment.

11. The method of claim 10, wherein the practitioner is a doctor.

12. The method of claim 10, wherein the practitioner is a dentist.

13. The method of claim 1, wherein the first party is a school, the second party is a teacher, and the appointment is a class at the school.

14. The method of claim 1, wherein the first party is a teacher, the second party is a school, and the appointment is a class at the school.

15. The method of claim 1, further comprising automatically sending appointment information to the first party via email, fax, or IVR.

16. The method of claim 1, further comprising automatically sending information to the second party via email, fax, or IVR.

17. An apparatus for scheduling an appointment, the apparatus comprising an appointment server containing instructions for:
(a) receiving appointment availability information from a second party;
(b) receiving an appointment request from a first party;
(c) comparing the request to the availability information;
(d) automatically scheduling the appointment if the request is for an available time based on the availability information; and
(e) automatically updating the appointment availability information to reflect the appointment.

18. The apparatus of claim 17, wherein the server contains instructions for verifying the appointment with the first party.

19. The apparatus of claim 17, wherein the server contains instructions for automatically prompting another request if the request is for an unavailable time based on the availability information.

20. The apparatus of claim 17, wherein the server contains instructions for requesting contact information from the first party.

21. The apparatus of claim 20, wherein the server contains instructions for automatically contacting the first party if there is any change in the appointment.

22. The apparatus of claim 17, wherein the first party is a passenger, the second party is an airline, and the appointment is an airline reservation.

23. The apparatus of claim 22, wherein the server contains instructions for receiving third party contact information, wherein the third party transports the first party to a departure airport or from a destination airport.

24. The apparatus of claim 23, wherein the server contains instructions for automatically sending information to the third party via email, fax or IVR.

25. The apparatus of claim 17, wherein the first party is a patron, the second party is a restaurant, and the appointment is a dining reservation.

26. The apparatus of claim 17, wherein the first party is a patient, the second party is a practitioner, and the appointment is an appointment at the practitioner's office.

27. The apparatus of claim 26, wherein the practitioner is a doctor.

28. The apparatus of claim 26, wherein the practitioner is a dentist.

29. The apparatus of claim 17, wherein the first party is a school, the second party is a teacher, and the appointment is a class at the school.

30. The apparatus of claim 17, wherein the first party is a teacher, the second party is a school, and the appointment is a class at the school.

31. The apparatus of claim 17, wherein the server contains instructions for automatically sending appointment information to the first party via email, fax, or IVR.

32. The apparatus of claim 17, wherein the server contains instructions for automatically sending information to the second party via email, fax, or IVR.
